(19) United States
(12) Patent Application Publication
(10) Pub. No.: US 2024/0257549 A1
(43) Pub. Date: Aug. 1, 2024

(54) INFORMATION PROCESSING SYSTEM, DOCUMENT TYPE IDENTIFICATION METHOD, AND MODEL GENERATION METHOD

(71) Applicant: PFU LIMITED, Ishikawa (JP)

(72) Inventor: Shota YOKOGAWA, Ishikawa (JP)

(21) Appl. No.: 18/633,146

(22) Filed: Apr. 11, 2024

Related U.S. Application Data
(63) Continuation of application No. PCT/JP2021/038148, filed on Oct. 14, 2021.

(51) Int. Cl. G06V 30/413; G06V 30/19; G06V 30/414

(52) U.S. Cl. CPC G06V 30/413; G06V 30/19147; G06V 30/414

(57) ABSTRACT

An information processing system includes: circuitry that: acquires a character recognition result of an identification target image; stores a frequently occurring word string of a predetermined document type; detects the frequently occurring word string from the character recognition result of the identification target image to acquire information on a position of the frequently occurring word string in the identification target document; generates a feature quantity of the identification target document using the information on the position, the feature quantity including a positional relationship feature quantity related to a positional relationship between the frequently occurring word string and another word string in the identification target document; stores a trained model that identifies the predetermined document type; and inputs the feature quantity of the identification target document to the trained model to identify whether the identification target document is a document of the predetermined document type.

### CROSS-REFERENCE TO RELATED APPLICATIONS

This patent application is a continuation application of International Application No. PCT/JP2021/038148, filed on Oct. 14, 2021, in the Japan Patent Office, the entire disclosure of which is hereby incorporated by reference herein.

### BACKGROUND

### Technical Field

The present disclosure relates to an information processing system, a document type identification method, and a model generation method.

### Related Art

In the related art, an apparatus including a scanner and a document-type registration/document-type determination circuit has been proposed. The scanner reads a document image. The document-type registration/document-type determination circuit classifies color information, such as red (R), green (G), blue (B) signals, of the read document into each previously divided color space to extract a feature quantity of the image. The document-type registration/document-type determination circuit compares the extracted feature quantity with a previously stored feature quantity to determine the type of the read document. The apparatus switches content of image processing, based on a determination result obtained by the document-type registration/document-type determination circuit.

An image reading device has also been proposed. The image reading device acquires image information of an image formed in a document. The image reading device performs a first recognition process for performing classification based on a feature quantity of the image, and a second recognition process for performing classification based on text information of the image. The image reading device uses one of or both of the first recognition process and the second recognition process to classify the image based on a processing result of one of the first recognition process and the second recognition process.

A document classification device has also been proposed which generates, through machine learning, a document classification model that is a model for classifying a document and outputs, based on an input document, identification information for identifying a result of classification. The document classification device acquires training data including a document and identification information associated with the document. The document classification device extracts, as feature quantities, words included in the document and character information which is a character string including one character of characters that make up the words or a plurality of consecutive characters in the words and which is one or more pieces of information extractable from the words. The document classification device performs machine learning based on the feature quantities extracted from the document and the identification information associated with the document to generate the document classification model.

A document classification device has also been proposed. The document classification device acquires image data representing an image of a document, and analyzes the image represented by the image data to acquire layout information representing a layout of components of each page of the document. The document classification device extracts a text area where texts are consecutively located spatially in the page, and recognizes a character string included in the text area. The document classification device extracts a visually emphasized character string from the recognized character string, and uses the extracted character string as a keyword. The document classification device generates, for each page, structural data representing a hierarchical structure in terms of the layout of the text area, and uses the structural data and the keyword to extract a logical structure of the document. The document classification device uses the extracted logical structure to classify and store the document.

### SUMMARY

According to an embodiment of the present disclosure, an information processing system includes circuitry. The circuitry acquires a character recognition result of an identification target image that is an image of an identification target document. The circuitry stores a frequently occurring word string of a predetermined document type. The circuitry detects the frequently occurring word string from the character recognition result of the identification target image to acquire information on a position of the frequently occurring word string in the identification target document. The circuitry generates a feature quantity of the identification target document using the information on the position, the feature quantity including a positional relationship feature quantity related to a positional relationship between the frequently occurring word string and another word string in the identification target document. The circuitry stores a trained model that identifies the predetermined document type, the trained model being generated through machine learning such that, in response to input of a feature quantity of a document including a positional relationship feature quantity related to a positional relationship between the frequently occurring word string and another word string in the document, information indicating appropriateness of the document being a document of the predetermined document type is output. The circuitry inputs the feature quantity of the identification target document to the trained model to identify whether the identification target document is a document of the predetermined document type.

According to an embodiment of the present disclosure, an information processing system includes circuitry. The circuitry acquires a character recognition result of each of a plurality of training images including a plurality of predetermined document type images that are images of documents of a predetermined document type having layouts different from one another. The circuitry acquires a frequently occurring word string of the predetermined document type. The circuitry detects the frequently occurring word string from the character recognition result of each of the plurality of training images to acquire information on a position of the frequently occurring word string in a document depicted in the training image. The circuitry generates a feature quantity of the document depicted in the training image using the information on the position of the frequently occurring word string in the document depicted in each of the plurality of training images, the feature quantity including a positional relationship feature quantity related to a positional relationship between the frequently occurring word string and another word string in the document depicted in the training image. The circuitry generates a trained model that identifies the predetermined document type, the trained model being generated through machine learning using training data. The training data associates the feature quantity of the document depicted in each of the plurality of training images with information indicating whether the document depicted in the training image is a document of the predetermined document type.

According to an embodiment of the present disclosure, a document type identification method includes acquiring a character recognition result of an identification target image that is an image of an identification target document; storing a frequently occurring word string of a predetermined document type; detecting the frequently occurring word string from the character recognition result of the identification target image to acquire information on a position of the frequently occurring word string in the identification target document; generating a feature quantity of the identification target document using the quantity related to a positional relationship between the frequently occurring word string and another word string in the identification target document; storing a trained model that identifies the predetermined document type, the trained model being generated through machine learning such that, in response to input of a feature quantity of a document including a positional relationship feature quantity related to a positional relationship between the frequently occurring word string and another word string in the document, information indicating appropriateness of the document being a document of the predetermined document type is output; and inputting the feature quantity of the identification target document to the trained model to identify whether the identification target document is a document of the predetermined document type.

According to an embodiment of the present disclosure, a model generation method includes acquiring a character recognition result of each of a plurality of training images including a plurality of predetermined document type images that are images of documents of a predetermined document type having layouts different from one another; acquiring a frequently occurring word string of the predetermined document type; detecting the frequently occurring word string from the character recognition result of each of the plurality of training images to acquire information on a position of the frequently occurring word string in a document depicted in the training image; generate a feature quantity of the document depicted in the training image using the information on the position of the frequently occurring word string in the document depicted in each of the plurality of training images, the feature quantity including a positional relationship feature quantity related to a positional relationship between the frequently occurring word string and another word string in the document depicted in the training image; and generating a trained model that identifies the predetermined document type, the trained model being generated through machine learning using training data. The training data associates the feature quantity of the document depicted in each of the plurality of training images with information indicating whether the document depicted in the training image is a document of the predetermined document type.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating a configuration of an information processing system according to a first embodiment of the present disclosure;

FIG. 2 is a schematic diagram illustrating a functional configuration of a training apparatus according to the first embodiment;

FIG. 3 is a diagram illustrating an example of a high-frequency word list according to the first embodiment;

FIG. 4 is a diagram illustrating an example of an invoice document according to the first embodiment;

FIG. 5 is a diagram for describing a position feature quantity according to the first embodiment;

FIG. 6 is a diagram illustrating an example of a coordinate information array according to the first embodiment;

FIG. 7 is a diagram for describing a distance feature quantity according to the first embodiment;

FIG. 8 is a diagram illustrating an example of a word string distance information array according to the first embodiment;

FIG. 9 is a diagram for describing a size feature quantity according to the first embodiment;

FIG. 10 is a diagram illustrating an example of a size information array according to the first embodiment;

FIG. 11 is a diagram for describing a row feature quantity according to the first embodiment;

FIG. 12 is a diagram illustrating an example of a row information array according to the first embodiment;

FIG. 13 is a diagram illustrating an example of a feature array according to the first embodiment;

FIG. 14 is a schematic diagram illustrating a functional configuration of an information processing apparatus according to the first embodiment;

FIG. 15 is a flowchart illustrating an overview of a flow of a training process according to the first embodiment;

FIG. 16 is a flowchart illustrating an overview of a flow of a frequently occurring word string extraction process according to the first embodiment;

FIG. 17 is a flowchart illustrating an overview of a flow of a frequently occurring word string detection process according to the first embodiment;

FIG. 18 is a flowchart illustrating an overview of a flow of a feature quantity generation process according to the first embodiment;

FIG. 19 is a flowchart illustrating an overview of a flow of an identification process according to the first embodiment;

FIG. 20 is a diagram illustrating an example of a high-frequency word list according to a second embodiment of the present disclosure; and

FIG. 21 is a flowchart illustrating an overview of a flow of an identification process according to the second embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An information processing system, method, and program according to embodiments of the present disclosure will be described below with reference to the accompanying drawings. The embodiments described below are illustratively present embodiments and do not limit the information processing system, method, and program disclosed herein to a specific configuration described below. In the implementation, specific configurations may be adopted appropriately according to the mode of implementation, and various improvements and modifications may be made.

Herein, description will be given of embodiments in which the information processing system, method, and program disclosed herein are implemented in a system that identifies an invoice (invoice document). However, the information processing system, method, and program disclosed herein are widely used for a technique of identifying any document kind (document type), and the target to which the present disclosure is applied is not limited to the examples presented in the embodiments.

### First Embodiment

### System Configuration

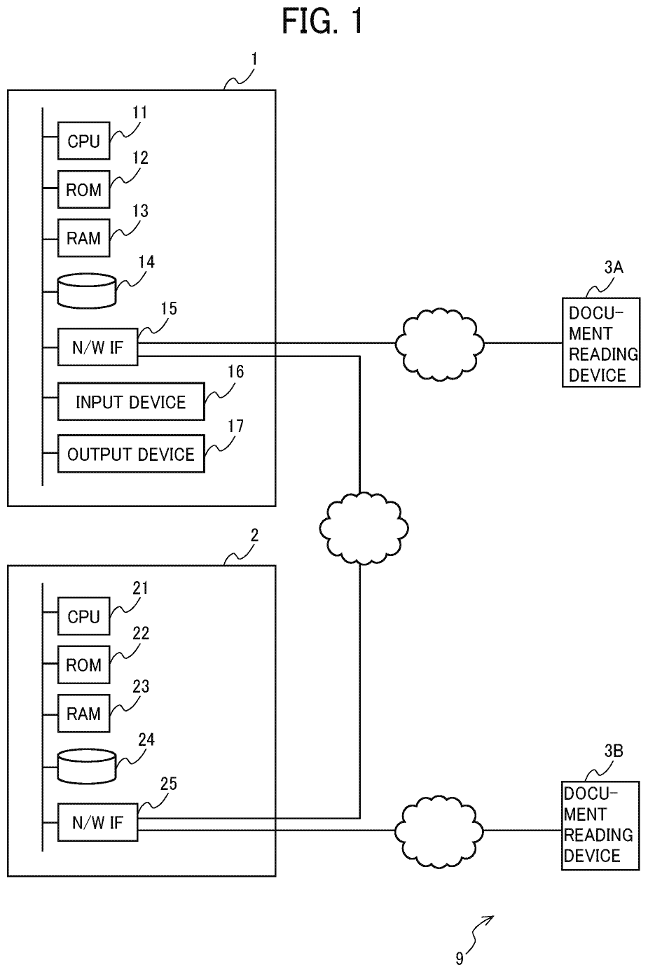

FIG. 1 is a schematic diagram illustrating a configuration of an information processing system 9 according to a first embodiment of the present disclosure. The information processing system 9 according to the present embodiment includes one or more information processing apparatuses 1, a training apparatus 2, and document reading devices 3 (3A and 3B) that are connected to and communicate with one another via a network. The training apparatus 2 performs a training process for identifying a predetermined document kind (hereinafter, referred to as a “document type”) to generate a trained model that identifies the predetermined document type. The information processing apparatus 1 uses the trained model generated in the training apparatus 2 to identify the document type of an identification target document (whether the identification target document is a document of the predetermined document type).

In the present embodiment, “invoice” is used as an example of the predetermined document type, and a training process and an identification process for identifying an invoice (invoice document) will be presented as an example. Note that the document type to be identified (predetermined document type) may be any document type other than the invoice, for example, a bill, a non-fixed-form receipt, a notice, a written guarantee, or the like. In the present embodiment, the term “document” refers to an electronic document (image) as well as a document of a paper medium.

The information processing apparatus 1 is a computer including a central processing unit (CPU) 11, a read-only memory (ROM) 12, a random access memory (RAM) 13, a storage device 14 such as an electrically erasable and programmable read-only memory (EEPROM) or a hard disk drive (HDD), a communication unit (N/W IF) 15 such as a network interface card, an input device 16 such as a keyboard or a touch panel, and an output device 17 such as a display. Regarding the specific hardware configuration of the information processing apparatus 1, any component may be omitted, replaced, or added as appropriate according to a mode of implementation. Further, the information processing apparatus 1 is not limited to an apparatus having a single housing. The information processing apparatus 1 may be implemented by multiple apparatuses using, for example, a so-called cloud or distributed computing technology.

The information processing apparatus 1 acquires a trained model and a high-frequency word list generated by the training apparatus 2 from the training apparatus 2, and stores the trained model and the high-frequency word list. The information processing apparatus 1 acquires a document image (identification target image) that is an image of an identification target document from the document reading device 3A. The information processing apparatus 1 uses the trained model and the high-frequency word list to identify the document type of the identification target document (document depicted in the identification target image).

Note that the document image is not limited to electronic data (image data) in Tagged Image File Format (TIFF), Joint Photographic Experts Group (JPEG), or Portable Network Graphics (PNG) and may be electronic data in Portable Document Format (PDF). Thus, the document image may be electronic data (PDF file) obtained through scanning and conversion of the document into a PDF file or electronic data (electronic document) initially created as a PDF file.

Note that the method of acquiring the identification target image is not limited to the example described above, and any method such as a method of acquiring the identification target image via another apparatus or a method of acquiring the identification target image by reading the corresponding data from the storage device 14 or external recording media such as a Universal Serial Bus (USB) memory, an Secure Digital (SD) memory card, and an optical disk may be used. Note that if the identification target image is not acquired from the document reading device 3A, the document reading device 3A may be omitted from the information processing system 9. Likewise, the method of acquiring the trained model and the high-frequency word list is not limited to the example described above, and any method may be used.

The training apparatus 2 is a computer including a CPU 21, a ROM 22, a RAM 23, a storage device 24, and a communication unit (N/W IF) 25. Regarding the specific hardware configuration of the training apparatus 2, any component may be omitted, replaced, or added as appropriate according to a mode of implementation. Further, the training apparatus 2 is not limited to an apparatus having a single housing. The training apparatus 2 may be implemented by multiple apparatuses using, for example, a so-called cloud or distributed computing technology.

The training apparatus 2 acquires document images (training images) from the document reading device 3B. The training apparatus 2 performs a training process using the training images to generate a trained model and a high-frequency word list used for identifying a predetermined document type (document of the predetermined document type).

Note that the method of acquiring the training images is not limited to the example described above, and any method such as a method of acquiring the training images via another apparatus or a method of acquiring the training images by reading the corresponding data from the storage device 24 or an external recording medium may be used. Note that if the training images are not acquired from the document reading device 3B, the document reading device 3B may be omitted from the information processing system 9. In the present embodiment, the information processing apparatus 1 and the training apparatus 2 are illustrated as separate apparatuses (separate housings). However, the configuration is not limited to this example, and the information processing system 9 may include a single device (housing) that performs both the training process and a document type identification process.

Each of the document reading devices 3 (3A and 3B) is a device that, in response to a scan instruction from a user, optically reads a document (original) of a paper medium to acquire a document image (original image), and is a scanner or a multifunction peripheral, for example. The document reading device 3A reads a document which the user desires to identify the document type, to acquire an identification target image. The document reading device 3B reads documents of a plurality of document types including the predetermined document type (for example, invoice) to acquire a plurality of training images. Note that the document reading devices 3A and 3B may be the same device (in the same housing). The document reading devices 3 are not limited to devices having a function of transmitting an image to another apparatus and may be an image-capturing devices such as a digital camera or a smartphone. The document reading devices 3 may be without the character recognition (OCR) function.

### Functional Configuration

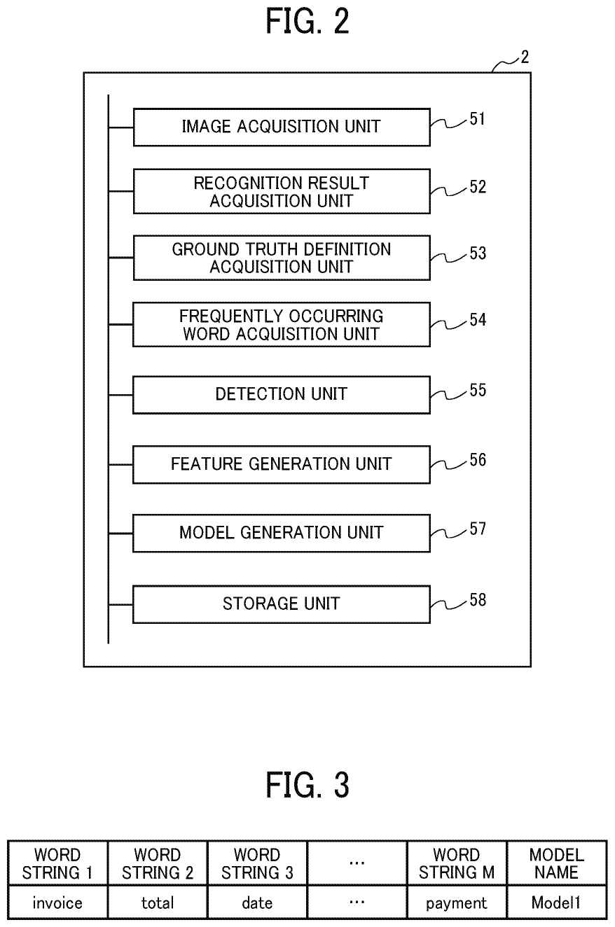

FIG. 2 is a schematic diagram illustrating a functional configuration of the training apparatus according to the present embodiment. The CPU 21 reads a program recorded in the storage device 24 to the RAM 23 and executes the program, so that the pieces of hardware of the training apparatus 2 are controlled. Consequently, the training apparatus 2 functions as an apparatus including an image acquisition unit 51, a recognition result acquisition unit 52, a ground truth definition acquisition unit 53, a frequently occurring word acquisition unit 54, a detection unit 55, a feature generation unit 56, a model generation unit 57, and a storage unit 58. Note that in the present embodiment and other embodiments described below, each of the functions of the training apparatus 2 are executed by the CPU 21 which is a general-purpose processor. However, some or all of these functions may be executed by one or more dedicated processors. Each of the functions of the training apparatus 2 is not limited to a function implemented by an apparatus (single apparatus) having a single housing, and may be implemented remotely and/or in a distributed manner (for example, in cloud).

The image acquisition unit 51 acquires a plurality of document images (training images) to be used in a training process. In the present embodiment, the image acquisition unit 51 acquires, as the training images, scanned images of documents of a plurality of document types including the predetermined document type (invoice). Note that the image acquisition unit 51 acquires images of documents (a plurality of documents) of the predetermined document type having layouts different from one another, as the images of documents of the predetermined document type (invoice). The images of documents of the predetermined document type (invoice) are hereinafter referred to as “predetermined document type images”. For example, in response to a scan instruction from a user, the document reading device 3B reads documents of a plurality of document types including the predetermined document type. The image acquisition unit 51 acquires, as the training images, scanned images resulting from the reading.

Note that the document image includes information included the document as an image. The training images and an identification target image (described low) are images on which preprocessing (such as trimming processing for adjusting the size to the size of the document) has been performed to match a target document (document depicted in the images). Consequently, the position in the document is treated to be equivalent to the position in the image. Note that in the present embodiment, document images of document types other than the predetermined document type are false training data during training. Any number of training images of the predetermined document type and any number of training images of the other document types may be used.

The recognition result acquisition unit 52 acquires a character recognition result (character string data) of each training image. The recognition result acquisition unit 52 applies OCR and reads the entire training image (entire area), and thus acquires a character recognition result (full-text OCR result) for the training image. Note that the character recognition result may have any data structure that includes a character recognition result for each character string (character string image) in the training image. Note that a method of acquiring the character recognition result is not limited to the example described above, and any method such as a method of acquiring the character recognition result via another apparatus such as a character recognition device that performs an OCR process or a method of acquiring the character recognition result by reading the character recognition result from an external recording medium or the storage device 24 may be used. Note that in the present embodiment, the term “character string” refers to a string (character sequence) including one or more characters. The characters include hiragana, katakana, kanji, alphabets, numbers, and symbols.

The ground truth definition acquisition unit 53 acquires a ground truth definition (ground truth definition table) in which each training image (identification information of the training image) is associated with information indicating whether a document depicted in the training image is a document of the predetermined document type. For example, in the ground truth definition, for a training image that is an image of the predetermined document type (invoice), a document type name (invoice), a label “1”, or the like is stored as the information indicating that the document type of the training image is the predetermined document type. For a training image used as the false data, a document type name of the training image, a label “0”, or the like is stored as the information indicating that the document type of the training image is not the predetermined document type. Note that the identification information of a training image may be any information that indicates the training image, such as a file name, a number, or a symbol. In the present embodiment, the ground truth definition acquisition unit 53 acquires the ground truth definition in response to the ground truth definition generated (defined) by the user being input to the training apparatus 2.

Note that the data structure for storing the information indicating whether a document is a document of the predetermined document type is not limited to a table format such as a comma-separated values (CSV) format, and may be any format. The method of acquiring the ground truth definition is not limited to the example described above, and any method such as a method of acquiring the ground truth definition via another apparatus or a method of acquiring the ground truth definition by reading the ground truth definition from the storage device 24 or an external recording medium may be used.

The frequently occurring word acquisition unit 54 acquires (extracts) one or more frequently occurring word strings (frequently occurring word strings of the predetermined document type) which are word strings that frequently occur in documents (images) of the predetermined document type. In the present embodiment, character strings that frequently appear in common in the plurality of training images that is the images of the predetermined document type are extracted as the frequently occurring word strings. Thus, word strings the serve as features of the predetermined document type are obtained. Note that the term “word string” refers to a string of one or more words (word sequence) and includes a word string including a plurality of words and a word string including a single word. Hereinafter, an image (training image) of a document of the predetermined document type is referred to as a “predetermined document type image”. The frequently occurring word string extraction method will be described in detail below.

The frequently occurring word acquisition unit 54 performs frequency analysis on a plurality of predetermined document type images to extract word strings (frequently occurring word strings) that frequently appear in the documents (images) of the predetermined document type. In the present embodiment, the frequency analysis is performed on each word string of consecutive two words and each word included in the character recognition result of each predetermined document type image. A predetermined number of (N, where N≥1) word strings are extracted as the frequently occurring word strings in descending order of the frequency. The frequently occurring word acquisition unit 54 generates a high-frequency word list storing the extracted frequently occurring word strings.

FIG. 3 is a diagram illustrating an example of the high-frequency word list according to the present embodiment. As illustrated in FIG. 3, the high-frequency word list for the predetermined document type stores frequently occurring word strings (word strings 1 to M, i.e., M frequently occurring word strings) of the predetermined document type and identification information of a trained model for identifying the predetermined document type. The identification information of the trained model may be any information indicating the trained model, such as a model name (Model 1), a number, or a symbol. As described above, the high-frequency word list may store frequently occurring word strings for an identification target document and the identification information of the corresponding trained model to associate the frequently occurring word strings with the trained model. Since the case of a single predetermined document type is described in the present embodiment, the identification information of the trained model may be omitted.

The high-frequency word list thus generated is stored in the storage unit 58. Note that in the frequency analysis, the degree of appearance (the number of times of appearance or the like) of each word string included in each predetermined document type image may be acquired, or a word string having a high appearance frequency in the plurality of predetermined document type images may be acquired. The frequently occurring word string extraction method is not limited to the example described above. A predetermined threshold value may be set for the frequency (number of times of appearance), and a word string having a frequency exceeding the threshold value may be extracted as the frequently occurring word string. In addition, as the method of acquiring the frequently occurring word strings (high-frequency word list), any method such as a method of acquiring the frequently occurring word strings (high-frequency word list) via another apparatus or a method of acquiring the frequently occurring word strings (high-frequency word list) by reading the corresponding data from the storage device 24 or an external recording medium may be used in addition to the example described above.

The detection unit 55 performs a detection process of the frequently occurring word strings extracted by the frequently occurring word acquisition unit 54 (the frequently occurring word strings stored in the high-frequency word list) in each training image. In the detection process, the detection unit 55 acquires, for each training image, information on a position of a frequently occurring word string in the document (training image) (i.e., position information related to the frequently occurring word string). For example, the detection unit 55 detects a frequently occurring word string included in the character recognition result of the training image, from among the frequently occurring word strings stored in the high-frequency word list. The detection unit 55 acquires information on the position of the detected frequently occurring word string in the training image (document) (position information related to the frequently occurring word string), from the character recognition result of the training image, for example. The detection unit 55 performs such processing for each training image to acquire information on the position of the frequently occurring word string in each document (training image).

The position information related to a frequently occurring word string is position information of the frequently occurring word string and/or position information of a row including the frequently occurring word string. In the present embodiment, both of the position information items are used. In the present embodiment, coordinates of the position are used as the position information. Thus, in the present embodiment, coordinates of the position of a frequently occurring word string and coordinates (row coordinates) of the position of a row including the frequently occurring word string are used as the position information related to the frequently occurring word string.

The coordinates of the position of a frequently occurring word string are, for example, coordinates indicating the position of a circumscribed rectangle of the frequently occurring word string in the document (training image) (such as coordinates of each vertex of the circumscribed rectangle). The row coordinates are, for example, coordinates indicating the position of a circumscribed rectangle of the row including the frequently occurring word string (circumscribed rectangle surrounding all the characters included in the row) (such as coordinates of each vertex of the circumscribed rectangle). Note that the position information related to a frequently occurring word string is not limited to the example described above, and may be any position information from which a feature quantity (described below) is to be generated (calculated). For example, the position information is not limited to coordinates of the position, and may be a combination of coordinates of a vertex of the circumscribed rectangle and information indicating the size of the circumscribed rectangle, for example. The coordinates of the position are not limited to coordinates of each vertex of the circumscribed rectangle, and may be coordinates of two diagonal vertices of the circumscribed rectangle.

The feature generation unit 56 generates a feature quantity related to a document depicted in each training image. The feature generation unit 56 uses the position information related to the frequently occurring word string, which is acquired by the detection unit 55, to generate a feature quantity related to the document depicted in the training image. The feature generation unit 56 generates a feature array in which feature quantities related to a document depicted in each training image are aggregated in an array form. In the training process (described below), the feature quantities (feature array) related to a document depicted in each training image are used as feature quantities for identifying the document type (as input to the trained model).

In the present embodiment, the feature generation unit 56 calculates feature quantities related to a document depicted in a training image, based on information on a frequently occurring word string. That is, feature quantities related to a frequently occurring word string are calculated as the feature quantities related to the document depicted in the training image. In the present embodiment, as the information on a frequently occurring word string, four information items (the position of the frequently occurring word string, the distances between the frequently occurring word strings, the size of the frequently occurring word string, and the sizes of a row including the frequently occurring word string) are used to generate the feature quantities related to the document depicted in the training image. More specifically, the feature quantities related to the document depicted in the training image are generated as feature quantities that include a feature quantity indicating the position of a frequently occurring word string (hereinafter, referred to as a “position feature quantity”), a feature quantity indicating the distances between the frequently occurring word strings (hereinafter, referred to as a “distance feature quantity”), a feature quantity indicating the size of the frequently occurring word string (hereinafter, referred to as “size feature quantity”), and a feature quantity indicating the size of a row including the frequently occurring word string (hereinafter, referred to as a “row feature quantity”).

Note that the position feature quantity and the size feature quantity are each an example of a feature quantity indicating an attribute of the frequently occurring word string (itself). The distance feature quantity and the row feature quantity are each an example of a feature quantity (hereinafter, referred to as a “positional relationship feature quantity”) related to a positional relationship between the frequently occurring word string and another word string in the document (training image). In other words, the feature quantity (row feature quantity) indicating the size of the row including the frequently occurring word string is a feature quantity indicating the possibility of another word string being included in the same row as the frequently occurring word string, and thus corresponds to the feature quantity related to the positional relationship between the frequently occurring word string and another word string.

Note that in the present embodiment, the case where the feature quantities of a document are feature quantities including the above-described four feature quantities will be described. However, the feature quantities of a document are not limited to the example described above, and may include one feature quantity among the four feature quantities or a combination of two or three feature quantities. The aforementioned four information items will be described below.

### Position of Frequently Occurring Word String

A word string (frequently occurring word string) that frequently appears in documents of the same document type is often written at similar positions even if the word string is not written at strictly at the same position in the documents of the same document type.

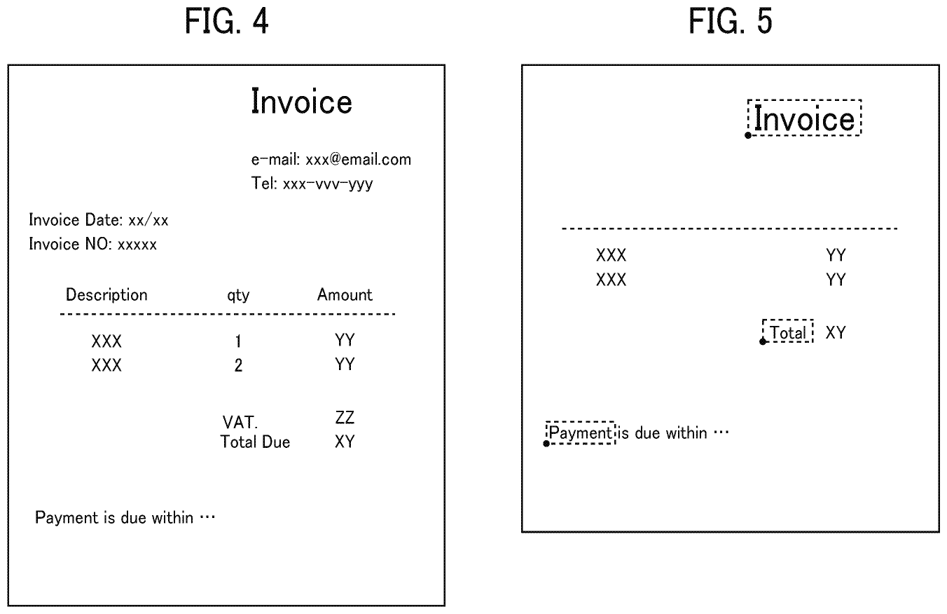

FIG. 4 is a diagram illustrating an example of an invoice document according to the present embodiment. As illustrated in FIG. 4, in the case of the invoice document, for example, “Invoice” which indicates the document type tends to be written at a top portion of the document and “Amount” indicating an amount tends to be written at a right portion of the document. That is, each document type has a tendency in the position where the frequently occurring word string of the document type is written. Thus, in the present embodiment, a feature quantity (position feature quantity) indicating the position of the frequently occurring word string is used as the feature quantity for identifying the document type.

Distance between Frequently Occurring Word Strings

Written positions of word strings (frequently occurring word strings) that frequently appear in documents of the same document type may vary in the documents of the same document type. However, a distance between the frequently occurring word strings is often substantially the same between the documents. For example, in the case of the invoice document, the written positions of “VAT.” which indicates a tax and “Total” which indicates a total amount may each vary in the documents. However, “VAT” and “Total” tend to be written vertically next to each other as illustrated in FIG. 4. That is, each document type has a tendency in the distance between the frequently occurring word strings of the document type. Thus, in the present embodiment, a feature quantity (distance feature quantity) indicating the distance between the frequently occurring word strings is used as the feature quantity for identifying the document type. Even if the written position of the frequently occurring word string vary depending in documents or the frequently occurring word string of the predetermined document type is a word string used also in documents of a document type other than the predetermined document type, the use of the distance feature quantity enables identification of the document type. Note that when the distance feature quantity is used as the feature quantity related to the document depicted in the training image, a plurality of frequently occurring word strings of the predetermined document type are to be present.

### Size of Frequently Occurring Word String

Word strings written in a document of each document type include a word string likely to be written in large characters such as a title and a word string likely to be written in small characters such as a note. For example, in the case of the invoice document, the word “Invoice” which indicates the document type tends to be written in a large size, and the words “e-mail” and “Tel” tend to be written in a small size as illustrated in FIG. 4. That is, each document type has a tendency in the size of the frequently occurring word string of the document type. Thus, in the present embodiment, a feature quantity (size feature quantity) indicating the size of the frequently occurring word string is used as the feature quantity for identifying the document type.

### Size of Row Including Frequently Occurring Word String

Word strings written in a document of each document type include a word string likely to exist in a short sentence. For example, as illustrated in FIG. 4, in the case of the invoice document, the word “Invoice” tends to often exit in short sentences such as “Invoice”, “Invoice Date”, and “Invoice NO” but tends to rarely exist in long sentences. On the other hand, in documents of a document type other than the invoice, it is not rare that the word “invoice” is included in long sentences. As described above, the usage of the word string may differ between the target document type and the other document types. That is, each document type has a tendency in whether the frequently occurring word string of the document type is included in short sentences. Thus, in the present embodiment, a feature quantity (row feature quantity) indicating the size of the row including the frequently occurring word string, which is a feature quantity indicating the possibility of the frequently occurring word string being included in a short sentence (or long sentence), is used as the feature quantity for identifying the document type.

The feature generation unit 56 generates the above-described four feature quantities for each training image, and generates a feature array in which the four feature quantities for all the training images are aggregated (stored). Note that in the present embodiment, an array storing each of the position feature quantity, the distance feature quantity, the size feature quantity, and the row feature quantity is referred to as an “information array”. In the present embodiment, a feature array is formed so that the four information arrays are aggregated. Each information array and each feature quantity stored in the feature array will be described below.

### Array A: Coordinate Information Array (Position Feature Quantity)

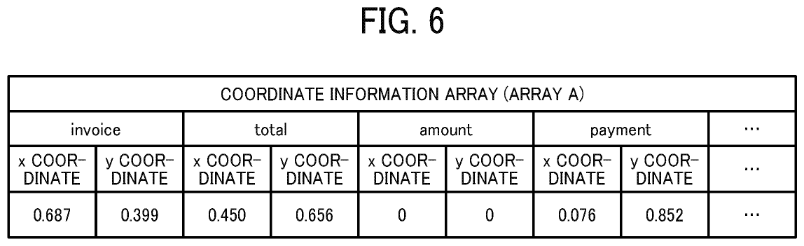

FIG. 5 is a diagram for describing the position feature quantity according to the present embodiment. FIG. 6 is a diagram illustrating an example of a coordinate information array according to the present embodiment. FIG. 6 illustrates an information array (coordinate information array) that stores a feature quantity (position feature quantity) indicating the position of each frequently occurring word string in the document (training image) illustrated in FIG. 5. Note that the position feature quantity is calculated (generated) using the coordinates of the frequently occurring word string (coordinates of the lower left point of the frequently occurring word string) acquired by the detection unit 55.

As illustrated in FIG. 6, the coordinate information array (array A) stores position feature quantities of all the frequently occurring word strings (such as “invoice”, “total”, “amount”, and “payment”). In the present embodiment, the coordinates (x coordinate and y coordinate) of the frequently occurring word string in the document are divided by the size of the document and normalized to a value from 0 to 1. This normalized coordinates of the frequently occurring word string is calculated as the position feature quantity. For example, a normalized coordinate, which is obtained by dividing the x coordinate of the frequently occurring word string by a length of the document in an x-axis direction, is acquired as the position feature quantity in the x-axis direction. Note that in the present embodiment, the coordinates of the lower left point of the frequently occurring word string (coordinates (coordinates of a circle in FIG. 5) of the lower left vertex of the circumscribed rectangle (dot-line rectangle in FIG. 5)) of the frequently occurring word string is used as the coordinates of the frequently occurring word string. However, the coordinates are not limited to this example, and coordinates of any of the lower right point, upper left point, or upper right point of the frequently occurring word string, coordinates of the barycenter, or the like may be used.

Note that the frequently occurring word string “amount” in the coordinate information array of FIG. 6 is a word string not included in the invoice document (training image) illustrated in FIG. 5 and is a word string that is determined as the frequently occurring word string as “amount” appears frequently in other invoice documents (training images), for example. The position feature quantity of the frequently occurring word string not included in a target document (training image) in this manner is set to a value (for example, 0) which is determined in advance as a value to be set when the frequently occurring word string is not present in the document (see FIG. 6).

Note that the position feature quantity is not limited to the normalized coordinates described above, and may be the coordinates of the frequently occurring word string in the document. In the example of FIG. 6, the coordinates of the frequently occurring word string are acquired with respect to origin that is the upper left vertex of the document. However, the origin is not limited to this example, and the coordinates may be acquired with respect to the origin that is any point such as an upper right vertex, a lower right vertex, or a lower left vertex of the document.

### Array B: Word String Distance Information Array (Distance Feature Quantity)

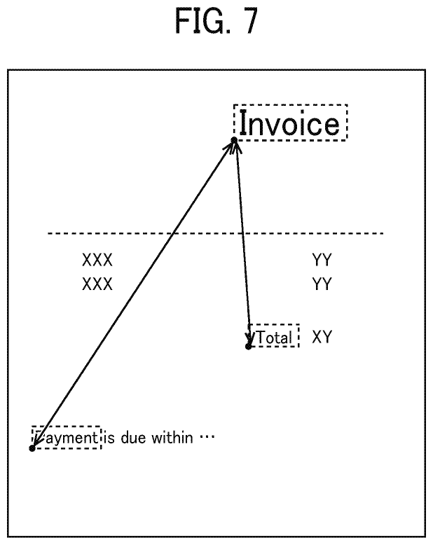

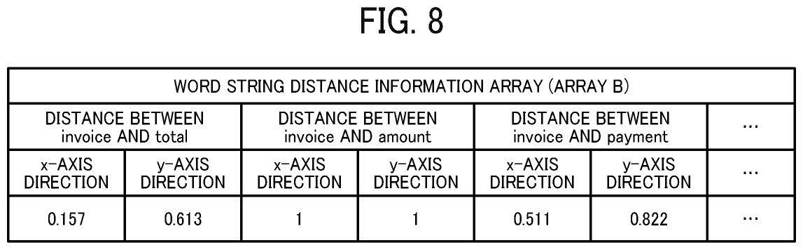

FIG. 7 is a diagram for describing the distance feature quantity according to the present embodiment. FIG. 8 is a diagram illustrating an example of a word string distance information array according to the present embodiment. FIG. 8 illustrates an information array (word string distance information array) that stores a feature quantity (distance feature quantity) indicating the distance between frequently occurring word strings in the document (training image) illustrated in FIG. 7. Note that the distance feature quantity is calculated (generated) using the coordinates of the position of each frequently occurring word string (coordinates of the lower left point of each frequently occurring word string) acquired by the detection unit 55.

As illustrated in FIG. 8, the word string distance information array (array B) stores distance feature quantities of all the combinations of the frequently occurring word strings (such as “invoice”, “total”, “amount”, and “payment”) (combinations of two word strings). In the present embodiment, the distance (x-axis direction and y-axis direction) between the frequently occurring word strings in the document are divided by the size of the document and normalized to a value from 0 to 1. This normalized distance between the frequently occurring word strings is calculated as the distance feature quantity. For example, a normalized distance, which is obtained by dividing the x-axis direction component (distance) of the distance between the frequently occurring word strings (the distance between the coordinates of the frequently occurring word strings (a length of an arrow in FIG. 7) by a length of the document in the x-axis direction, is acquired as the distance between the frequently occurring word strings in the x-axis direction.

Note that the invoice document (training image) illustrated in FIG. 7 does not include the frequently occurring word string “amount”. The feature quantity (distance feature quantity) indicating a distance to the frequently occurring word string not included in the document (training image) in this manner is set to a value (for example, 1) which is determined in advance as a value to be set when the frequently occurring word string is not present in the document (see FIG. 8). Note that the distance feature quantity is not limited to the normalized distance described above, and may be the distance between the frequently occurring word strings in the document.

### Array C: Size Information Array (Size Feature Quantity)

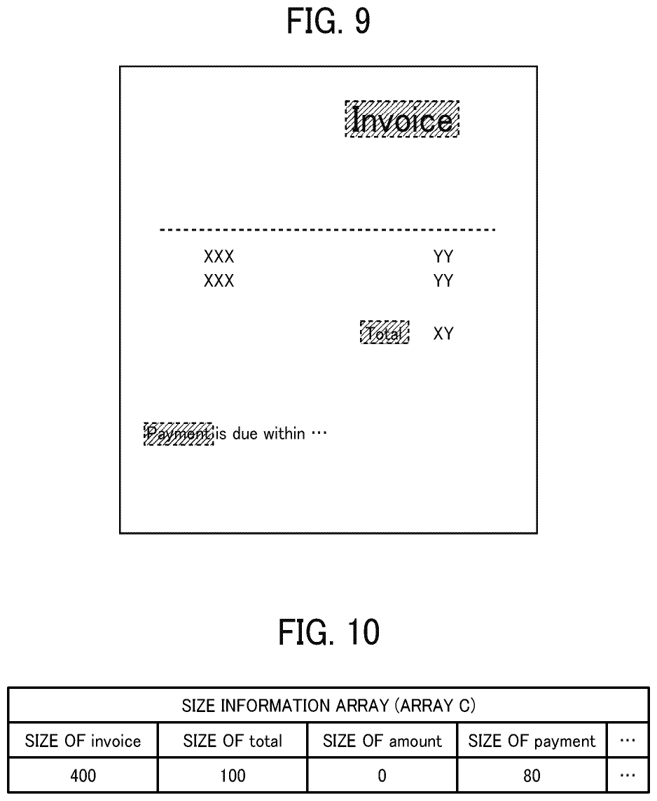

FIG. 9 is a diagram for describing the size feature quantity according to the present embodiment. FIG. 10 is a diagram illustrating an example of a size information array according to the present embodiment. FIG. 10 illustrates an information array (size information array) that stores a feature quantity (size feature quantity) indicating the size of each frequently occurring word string in the document (training image) illustrated in FIG. 9. Note that the size feature quantity is calculated (generated) using the coordinates of the position of each frequently occurring word string (coordinates of the upper left, lower left, upper right, and lower right points of each frequently occurring word string) acquired by the detection unit 55.

As illustrated in FIG. 10, the size information array (array C) stores size feature quantities of all the frequently occurring word strings (such as “invoice”, “total”, “amount”, and “payment”). In the present embodiment, an area of the circumscribed rectangle of each frequently occurring word string in the document (an area of each hatched portion in FIG. 9) is calculated as the size feature quantity. Note that in the present embodiment, the area of the circumscribed rectangle is represented in square millimeters. However, the unit of the area of the circumscribed rectangle is not limited to this example.

Note that the frequently occurring word string “amount” in the size information array of FIG. 10 is a word string not included in the invoice document (training image) illustrated in FIG. 9. The size feature quantity of the frequently occurring word string not included in the document (training image) in this manner is set to a value (for example, 0) which is determined in advance as a value to be set when the frequently occurring word string is not present in the document (see FIG. 10).

Note that the size feature quantity is not limited to the above-described area of the circumscribed rectangle of the frequently occurring word string in the document, and may be a normalized size of the frequently occurring word string, which is obtained by dividing the size of the frequently occurring word string (area of the circumscribed rectangle) in the document by the size of the document and is normalized to a value from 0 to 1.

### Array D: Row Information Array (Row Feature Quantity)

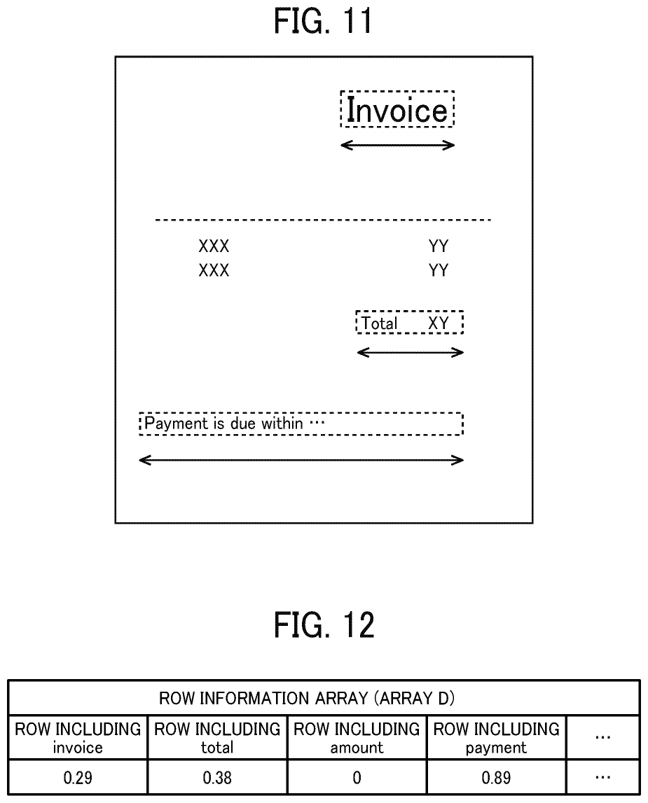

FIG. 11 is a diagram for describing the row feature quantity according to the present embodiment. FIG. 12 is a diagram illustrating an example of a row information array according to the present embodiment. FIG. 12 illustrates an information array (row information array) that stores a feature quantity (row feature quantity) indicating the size of a row including each frequently occurring word string in the document (training image) illustrated in FIG. 11. Note that the row feature quantity is calculated (generated) using the coordinates (row coordinates) of the position of a row including each frequently occurring word string acquired by the detection unit 55.

As illustrated in FIG. 12, the row information array (array D) stores row feature quantities of all the frequently occurring word strings (such as “invoice”, “total”, “amount”, and “payment”). In the present embodiment, the length of a row including each frequently occurring word string in the document (length of a double-headed arrow in FIG. 11) is divided by the length of the document in the same direction as the length direction of the row and normalized to a value from 0 to 1. This normalized length of the row is calculated as the row feature quantity.

The frequently occurring word string “amount” in the row information array of FIG. 12 is a word string not included in the invoice document (training image) illustrated in FIG. 11. The row feature quantity of the frequently occurring word string not included in the document (training image) in this manner is set to a value (for example, 0) which is determined in advance as a value to be set when the frequently occurring word string is not present in the document (see FIG. 12). Note that the row feature quantity is not limited to the above-described normalized length of the row, and may be a length of the row including the frequently occurring word string in the document, a value obtained by dividing the length of the row including the frequently occurring word string by the length of the frequently occurring word string in the document (a ratio of the length of the row to the length of the frequently occurring word string), an area of the row including the frequently occurring word string in the document (area of the circumscribed rectangle of the row), a value obtained by dividing the area of the row by an area of the document (a ratio of the size of the row to the size of the document), or the like.

### Feature Array

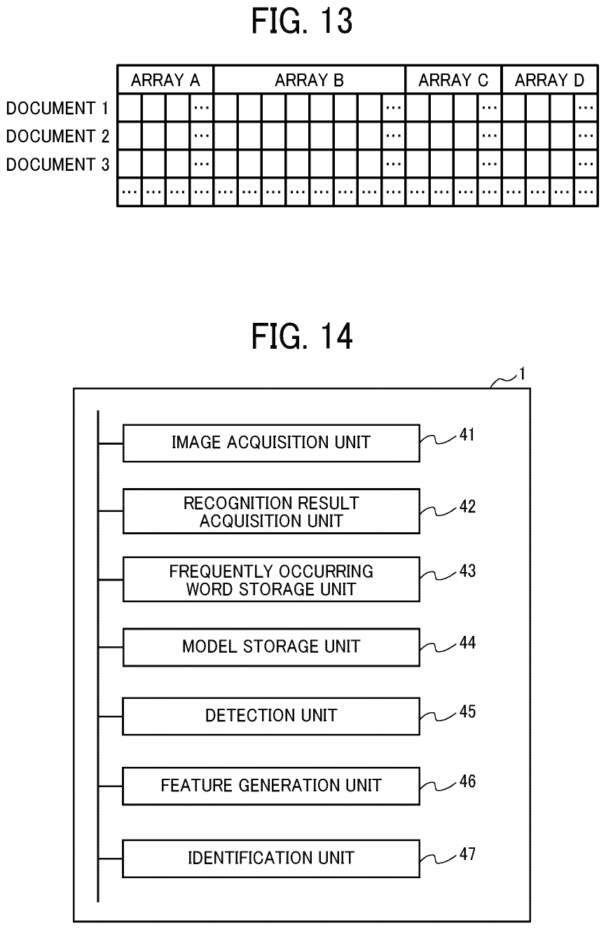

FIG. 13 is a diagram illustrating an example of the feature array according to the present embodiment. As illustrated in FIG. 13, the feature array is formed so that the above-described information arrays (arrays A, B, C, and D) are aggregated. The feature array stores the information arrays (arrays A, B, C, and D) generated for each document (each training image).

Note that when a plurality of identical word strings appear in a single document (image), which word string among the plurality of identical word strings is to be used for the feature quantity may be selected. Any method may be used to determine which word string is to be used. In the case of the array A, for example, one of a word string having the largest Y coordinate and a word string having the smallest Y coordinate may be used among the plurality of identical word strings, or both of the word strings may be used. In the case of the array B, for example, the word string having the smallest distance to another frequently occurring word string may be used. In the case of the array C, for example, one of a word string having the largest size and a word string having the smallest size among the frequently occurring word strings may be used, or both of the word strings may be used. In the case of the array D, for example, the word string used in the array A may be used, or one of a word string with the largest row size and a word string with the smallest row size may be used.

The model generation unit 57 performs machine learning (supervised learning) to generate a trained model for identifying the predetermined document type. In the machine learning, training data (dataset (labeled training data) of a feature quantity and information indicating whether a document type is the predetermined document type) is used. In the training data, feature quantities (feature array) of a document depicted in each training image are associated with information (ground truth label) indicating whether the document depicted in the training image is the document of the predetermined document type. The information indicating whether the document depicted in the training image is the document of the predetermined document type, which is the ground truth label, is information based on the ground truth definition acquired by the ground truth definition acquisition unit 53. Through machine learning using this training data, the feature quantities of the predetermined document type can be learned.

In this manner, an identifier can be generated that determines, in response to receipt of a feature quantity of a target document (at least including a positional relationship feature quantity indicating the positional relationship between a frequently occurring word string and another word string in the document), whether the target document is the document of the predetermined document type. More specifically, an identifier (trained model) can be generated that outputs, in response to receipt of a feature quantity of a document, information indicating the appropriateness of the document being the document of the predetermined document type. Note that the information indicating the appropriateness of the document being the document of the predetermined document type is information (such as a label) indicating whether the document is the document of the predetermined document type and/or information (such as a reliability or likelihood) indicating a probability of the document being the document of the predetermined document type. The generated trained model is stored in the storage unit 58.

The method of machine learning may be any method. Any method among the decision tree, random forest, gradient boosting, linear regression, support vector machine (SVM), neural network, and the like may be used.

The storage unit 58 stores the frequently occurring word strings (high-frequency word list) extracted for the predetermined document type by the frequently occurring word acquisition unit 54, and the trained model generated for the predetermined document type by the model generation unit 57. The storage unit 58 may store the high-frequency word list (frequently occurring word strings) in association with the trained model.

FIG. 14 is a schematic diagram illustrating a functional configuration of the information processing apparatus according to the present embodiment. The CPU 11 of the information processing apparatus 1 reads a program recorded in the storage device 14 to the RAM 13 and executes the program, so that the pieces of hardware of the information processing apparatus 1 are controlled. Consequently, the information processing apparatus 1 functions as an apparatus including an image acquisition unit 41, a recognition result acquisition unit 42, a frequently occurring word storage unit 43, a model storage unit 44, a detection unit 45, a feature generation unit 46, and an identification unit 47. In the present embodiment and other embodiments described below, the functions of the information processing apparatus 1 are executed by the CPU 11 which is a general-purpose processor. Alternatively, a part or all of these functions may be executed by one or multiple dedicated processors. Each of the functions of the information processing apparatus 1 is not limited to a function implemented by an apparatus (single apparatus) having a single housing, and may be implemented remotely and/or in a distributed manner (for example, in cloud).

The image acquisition unit 41 acquires a document image subjected identification in an identification process of a document type. The document image subjected to identification is hereinafter referred to as an “identification target image”. In the present embodiment, for example, in response to a scan instruction from a user, the document reading device 3A reads a document (original) subjected to identification. The image acquisition unit 41 acquires, as the identification target image, a scanned image resulting from the reading.

The recognition result acquisition unit 42 acquires a character recognition result (full-text OCR result) of the identification target image. Note that since a process of the recognition result acquisition unit 42 is substantially the same as the process of the recognition result acquisition unit 52, a detailed description is omitted.

The frequently occurring word storage unit 43 stores the high-frequency word list generated in the training apparatus 2 and to be used for identifying the predetermined document type. Since details of the high-frequency word list have been described in the description of the functional configuration (the frequently occurring word acquisition unit 54) of the training apparatus 2, the description is omitted.

The model storage unit 44 stores a trained model that is generated in the training apparatus 2 and is for identifying a predetermined document type. Since details of the trained model have been described in the description of the functional configuration (the model generation unit 57) of the training apparatus 2, the description is omitted.

The detection unit 45 performs a detection process of frequently occurring word strings (frequently occurring word strings stored in the high-frequency word list stored in the frequently occurring word storage unit 43) in the identification target image. In the detection process, the detection unit 45 acquires information on the position of each frequently occurring word string in the document (identification target document) depicted in the identification target image (i.e., position information related to each frequently occurring word string). Note that since a process of the detection unit 45 is substantially the same as the process of the detection unit 55, a detailed description is omitted.

The feature generation unit 46 generates feature quantities of the document (identification target document) depicted in the identification target image. The feature generation unit 46 uses the position information related to the frequently occurring word strings, which is acquired by the detection unit 45, to generate the feature quantities of the identification target document. The feature generation unit 46 then generates a feature array into which the feature quantities of the identification target document are formed. In an identification process (described below), the feature quantities (feature array) of the identification target document are used as the feature quantities for identifying the document type (as input of the trained model). Similarly, to the above-described feature quantities of the document depicted in the training image, the feature quantities of the identification target document are generated as feature quantities including the position feature quantity, the distance feature quantity, the size feature quantity, and the row feature quantity.

Since the feature quantities (feature array) of the identification target document and the feature quantity generation method are substantially the same as the feature quantities (feature array) of the document depicted in the training image and the feature quantity generation method that have been described above, the description is omitted. The arrangement of the feature quantities in the feature array of the identification target image (positions of the feature quantities in the array) are the same as the arrangement of the corresponding feature quantities in the feature array of the training image.

The identification unit 47 inputs the feature quantities (feature array) of the identification target document to the trained model to identify whether the identification target document is the document of the predetermined document type. Specifically, the identification unit 47 receives the trained model for identifying the predetermined document type, which is stored in the model storage unit 44, and inputs the feature quantities (feature array) of the identification target document, which are generated by the feature generation unit 46, to the trained model to determine whether the document is the document of the predetermined document type. The identification unit 47 outputs the identified result.

As described above, in response to the feature quantities of the document being input to the trained model, information (a label and/or a likelihood) indicating the appropriateness of the document being the document of the predetermined document type is output from the trained model. In the present embodiment, the identification unit 47 inputs the feature quantities of the identification target document to the trained model, and thus acquires information indicating whether the identification target document is the document of the predetermined document type (a label, for example, a label of “1” when the identification target document is the document of the predetermined document type; otherwise, a label of “0”) and information (such as a reliability or likelihood) indicating a probability of the identification target document being the document of the predetermined document type.

Note that, for example, if a likelihood of the identification target document being the document of the predetermined document type exceeds a likelihood of the identification target document not being the document of the predetermined document type or exceeds a predetermined threshold value, it is determined that the identification target document is the document of the predetermined document type. Accordingly, the identification unit 47 may acquire the likelihood of the identification target document being the document of the predetermined document type from the trained model, and determine whether the identification target document is the document of the predetermined document type based on the acquired likelihood.

### Process Flow

A flow of a training process performed by the training apparatus 2 according to the present embodiment will be described. Note that the specific processing content and processing order described below are examples for implementing the present disclosure. The specific processing content and processing order may be appropriately selected according to the mode of implementation of the present disclosure.

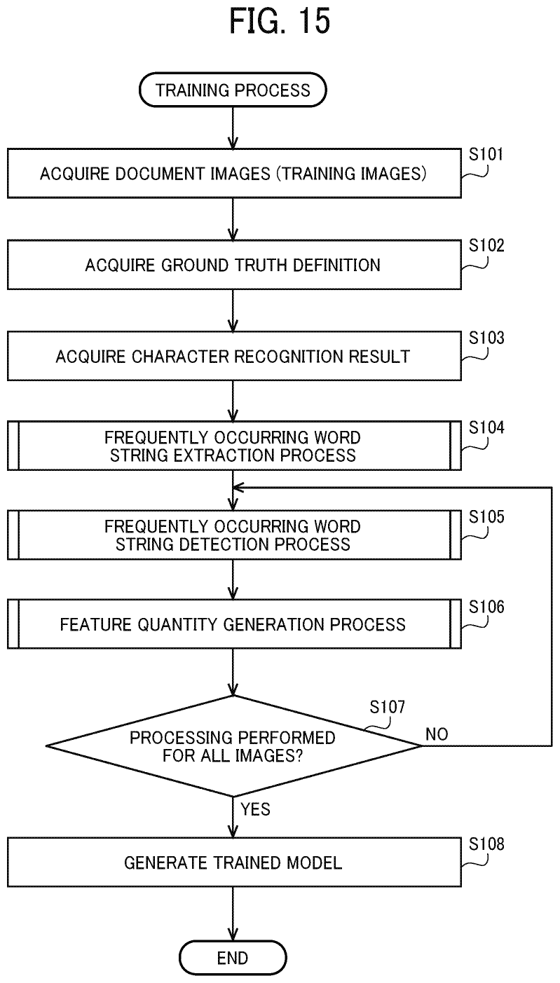

FIG. 15 is a flowchart illustrating an overview of the flow of the training process according to the present embodiment. The process illustrated by this flowchart is performed by the training apparatus 2 in response to a trigger such as receipt of a scan instruction for a document. Note that this flowchart may be performed in response to a trigger such as receipt of a user instruction to acquire a document image stored in the storage device 24. Note that this flowchart illustrates a process to be performed in the case where the document type to be identified (predetermined document type) is “invoice”.

In step S101, a plurality of document images (training images) are acquired. The image acquisition unit 51 acquires training images (scanned images) including a plurality of predetermined document type images that are images of document of the predetermined document type image (invoice) having layouts different from one another. The process then proceeds to step S102.

In step S102, a ground truth definition is acquired. The ground truth definition acquisition unit 53 acquires a ground truth definition in which each training image (identification information of each training image) is associated with information indicating whether a document depicted in the training image is a document of the predetermined document type (invoice). The process then proceeds to step S103.

In step S103, a character recognition result (full-text OCR result) is acquired. The recognition result acquisition unit 52 performs character recognition on each of the training images acquired in step S101 to acquire a character recognition result for each of the training images. Note that the order of steps S102 and S103 may be reversed. The order of steps S101 and S102 may also be reversed. The process then proceeds to step S104.

In step S104, a frequently occurring word string extraction process is performed. In the frequently occurring word string extraction process, the character recognition results of the plurality of training images (predetermined document type images) that are images of the predetermined document type (invoice) to extract frequently occurring word strings of the predetermined document type. Details of the frequently occurring word string extraction process will be described below with reference to FIG. 16. The process then proceeds to step S105.

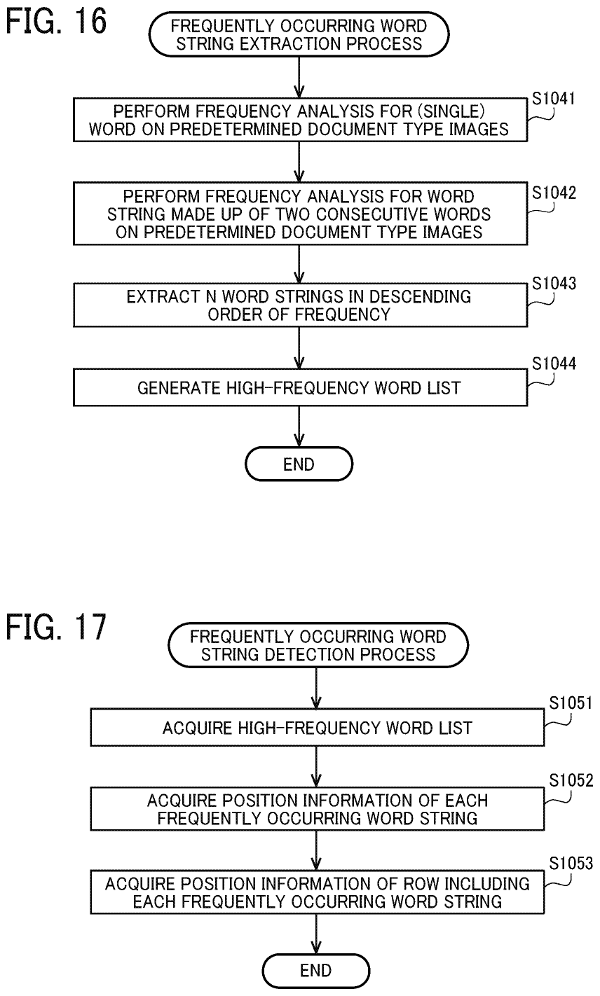

In step S105, a frequently occurring word string detection process is performed. In the frequently occurring word string detection process, processing of detecting the frequently occurring word strings extracted in step S104 is performed in the training images acquired in step S101. In the frequently occurring word string detection process, position information related to each frequently occurring word string (position information of the frequently occurring word string in the document (training image) and position information of a row including the frequently occurring word string in the document (training image)) is acquired. Details of the frequently occurring word string detection process will be described below with reference to FIG. 17. The process then proceeds to step S106.

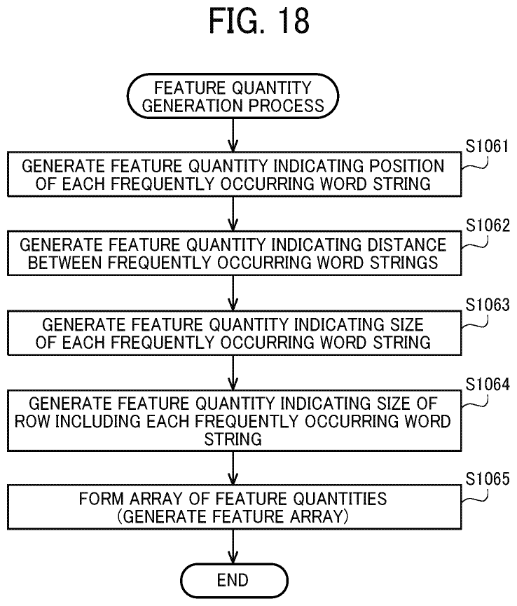

In step S106, a feature quantity generation process is performed. In the feature quantity generation process, feature quantities (feature array) of the document depicted in each training image acquired in step S101 are generated based on the position information acquired in step S105. Details of the feature quantity generation process will be described below with reference to FIG. 18. The process then proceeds to step S107.

In step S107, it is determined whether the feature quantities have been generated (the processing of steps S105 and S106 has been performed) for all the training images. The CPU 21 determines whether the feature quantities of the document depicted in the training image have been generated for each of the training images. If the processing has not been performed for all the training images (NO in step S107), the process returns to step S105 and the processing is performed for each training image yet to be processed. On the other hand, if the processing has been performed for all the training images (YES in step S107), the process proceeds to step S108.

In step S108, a trained model for identifying the predetermined document type is generated. The model generation unit 57 performs machine learning using training data to generate a trained model for identifying the predetermined document type. In the training data, the feature quantities (feature array), generated in step S107, of the document depicted in each training image are associated with information indicating whether the document depicted in the training image is the document of the predetermined document type (invoice) (i.e., information based on the ground truth definition acquired in step S102). The process illustrated by the flowchart then ends.

FIG. 16 is a flowchart illustrating an overview of a flow of the frequently occurring word string extraction process according to the present embodiment. The process illustrated by this flowchart is performed in response to a trigger that is the end of step S103 of FIG. 15. Note that this flowchart also illustrates a process to be performed in the case where the predetermined document type is “invoice”.

In step S1041, frequency analysis for a (single) word is performed on the plurality of predetermined document type images. For example, the frequently occurring word acquisition unit 54 uses the character recognition results of the plurality of predetermined document type images acquired in step S103 to acquire (counts) the number of times each word included in each predetermined document type image appears in the plurality of predetermined document type images. The process then proceeds to step S1042.

In step S1042, frequency analysis for a word string made up of two consecutive words is performed on the plurality of predetermined document type images. The frequently occurring word acquisition unit 54 uses the character recognition results of the plurality of predetermined document type images acquired in step S103 to acquire (counts) the number of times each word string (word string made up of two consecutive words) included in each predetermined document type image appears in the plurality of predetermined document type images. The process then proceeds to step S1043.

In step S1043, a predetermined number of (N) word strings are extracted as frequently occurring word strings in descending order of the frequency (the number of times of appearance). Based on the results of the frequency analysis performed in steps S1041 and S1042, the frequently occurring word acquisition unit 54 extracts, as the frequently occurring word strings of the predetermined document type (invoice), a predetermined number of (N) word strings among the word strings (including words) included in each predetermined document type image in descending order of the number of times of appearance. The process then proceeds to step S1044.

In step S1044, a high-frequency word list is generated. The frequently occurring word acquisition unit 54 generates a high-frequency word list storing the frequently occurring word strings extracted in step S1043. The storage unit 58 stores the generated high-frequency word list. The process illustrated by the flowchart then ends.

FIG. 17 is a flowchart illustrating an overview of a flow of the frequently occurring word string detection process according to the present embodiment. The process illustrated by this flowchart is performed in response to a trigger that is the end of step S104 of FIG. 15.

In step S1051, the high-frequency word list is acquired. The detection unit 55 acquires the high-frequency word list stored in step S1044. The process then proceeds to step S1052.

In step S1052, position information of each frequently occurring word string is acquired. The detection unit 55 detects frequently occurring word strings included in the character recognition result of each training image among the frequently occurring word strings stored in the high-frequency word list acquired in step S1051, and acquires, for each of the detected frequently occurring word strings, information (coordinate information) on the position of the frequently occurring word string in the document depicted in the training image. The process then proceeds to step S1053.

In step S1053, position information of a row including each frequently occurring word string is acquired. The detection unit 55 detects frequently occurring word strings included in the character recognition result of each training image among the frequently occurring word strings stored in the high-frequency word list acquired in step S1051, and acquires, for each of the detected frequently occurring word strings, information (coordinate information) on the position of a row including the frequently occurring word string in the document depicted in the training image. The process illustrated by the flowchart then ends. Note that the order of steps S1052 and S1053 may be reversed.

FIG. 18 is a flowchart illustrating an overview of a flow of the feature quantity generation process according to the present embodiment. The process illustrated by this flowchart is performed in response to a trigger that is the end of step S105 of FIG. 15.

In step S1061, a feature quantity indicating a position of each frequently occurring word string is generated. The feature generation unit 56 uses the position information acquired in step S1052 to generate a feature quantity indicating the position of each frequently occurring word string (feature quantity stored in the array A of FIG. 6). The process then proceeds to step S1062.

In step S1062, a feature quantity indicating a distance between frequently occurring word strings is generated. The feature generation unit 56 uses the position information acquired in step S1052 to generate a feature quantity indicating a distance between frequently occurring word strings (feature quantity stored in the array B of FIG. 8). The process then proceeds to step S1063.

In step S1063, a feature quantity indicating the size of each frequently occurring word string is generated. The feature generation unit 56 uses the position information acquired in step S1052 to generate a feature quantity indicating the size of each frequently occurring word string (feature quantity stored in the array C of FIG. 10). The process then proceeds to step S1064.

In step S1064, a feature quantity indicating the size of a row including each frequently occurring word string is generated. The feature generation unit 56 uses the position information acquired in step S1053 to generate a feature quantity indicating the size of a row including each frequently occurring word string (feature quantity stored in the array D of FIG. 12). Note that steps S1061 to S1064 may be performed in any order. The process then proceeds to step S1065.

In step S1065, the feature quantities are formed into an array. The feature generation unit 56 generates a feature array (each row in FIG. 13) to which the feature quantities generated in steps S1061 to S1064 are aggregated. The process illustrated by the flowchart then ends. Note that the processing of step S106 is performed for each training image, so that the feature quantities of each training image (feature quantities of the document depicted in each training image) are stored in the feature array. Consequently, the feature array illustrated in FIG. 13 is generated.

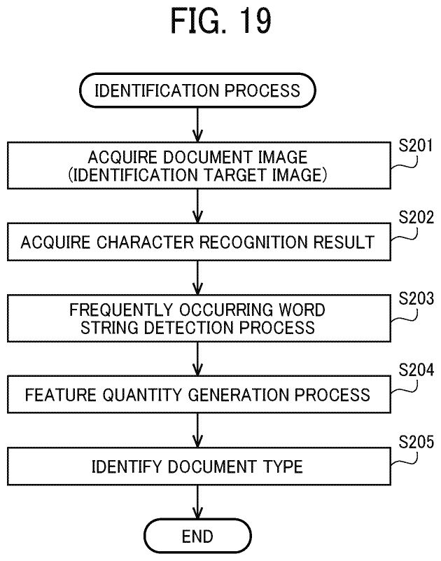

FIG. 19 is a flowchart illustrating an overview of a flow of the identification process according to the present embodiment. The process illustrated by this flowchart is performed by the information processing apparatus 1 in response to a trigger such as receipt of a scan instruction for a document. Note that this flowchart may be performed in response to a trigger such as receipt of a user instruction to acquire a document image stored in the storage device 14. Note that this flowchart also illustrates a process to be performed in the case where the document type to be identified is “invoice”.

In step S201, a document image (identification target image) is acquired. The image acquisition unit 41 acquires a scanned image of an identification target document. The process then proceeds to step S202.

In step S202, a character recognition result (full-text OCR result) is acquired. The recognition result acquisition unit 42 performs character recognition on the identification target image acquired in step S201 to acquire a character recognition result for the identification target image. The process then proceeds to step S203.

In step S203, a frequently occurring word string detection process is performed. In the frequently occurring word string detection process, processing of detecting the frequently occurring word strings stored in the frequently occurring word storage unit 43 is performed in the identification target image acquired in step S201. In the frequently occurring word string detection process, position information related to each frequently occurring word string (position information of the frequently occurring word string in the identification target document and position information of a row including the frequently occurring word string in identification target document) is acquired. Since the frequently occurring word string detection process is substantially the same as the process illustrated in FIG. 17, a detailed description is omitted. The process then proceeds to step S204.

In step S204, a feature quantity generation process is performed. In the feature quantity generation process, feature quantities (feature array) of the document (identification target document) depicted in the identification target image acquired in step S201 are generated based on the position information acquired in step S203. Since the feature quantity generation process is substantially the same as the process illustrated in FIG. 18, a detailed description is omitted. The process then proceeds to step S205.

In step S205, the document type of the identification target document is identified. The identification unit 47 receives the trained model for identifying the predetermined document type (invoice), which is stored in the model storage unit 44. The identification unit 47 then inputs the feature quantities (feature array) of the identification target document, which are generated in step S204, to the received trained model to identify whether the identification target document is the document of the predetermined document type (invoice). The identification unit 47 outputs the identified result. The process illustrated by the flowchart then ends.

As described above, in the present embodiment, the training apparatus 2 generates a trained model that identifies, from feature quantities of a document (including positional relationship feature quantities on positional relationships between each frequently occurring word string of the predetermined document type and another word string in the document), whether the document is the document of the predetermined document type. Thus, the training apparatus 2 can generate a model (identifier) that appropriately identifies the document type even for documents (such as semi-fixed-format forms) having unfixed layouts (various layouts). In the present embodiment, the information processing apparatus 1 uses the trained model that identifies, from feature quantities of a document, whether the document is a document of the predetermined document type, to identify whether an identification target document is the document of the predetermined document type. Thus, the information processing apparatus 1 can appropriately identify the document type even for documents having unfixed layouts. That is, even documents having different layouts can be identified as documents of the same document type.

In documents having unfixed layouts, the position of the frequently occurring word string may vary in the documents. However, in the present embodiment, positional relationship feature quantities (distance feature quantity and row feature quantity) related to the positional relationship of a frequently occurring word string of the predetermined document type and another word string in the document are used as the feature quantities of the document. This thus can increase the identification accuracy as compared with the case of using feature quantity indicating the position of the frequently occurring word string.

Identification of the invoice document has been desired. However, the invoice document has various layouts. There is no specific word unexceptionally written in the invoice document, and the written position of the frequently occurring word is not fixed (varies in each document). Therefore, it is difficult to identify the invoice document with a simple rule. The document type such as a receipt or a name card has been identified based on the size of the document. However, the size of the invoice document is often A4 size, and there is no feature in the document size. It is difficult to identify the invoice document with this method.

In a method of the related art, a particular document type is identified based on the presence or absence of a particular word written in the particular document type and the position of the particular word. However, there is no word uniquely written in the invoice document. A frequently occurring word in the invoice document is also present (appears) in other document types, and even the same item (information) is written as different words. Thus, it is difficult to create a rule based on the presence or absence of the particular word.

A method that uses ruled line information to identify a form is also present. However, since the invoice document has various layouts, the ruled line also varies depending on the document. Thus, it is difficult to identify the invoice document with this method.

However, in the present embodiment, positional relationship feature quantities (distance feature quantity and row feature quantity) related to the positional relationship of a frequently occurring word string of the predetermined document type and another word string in the document are used as the feature quantities of the document. This allows the invoice document having an unfixed layout to be identified.

In the present embodiment, the training apparatus 2 performs training by machine learning, and thus can automatically generate the identifier (trained model). In addition, training by machine learning enables more complicated identification with a high accuracy.

### Second Embodiment

In the first embodiment described above, implementation in the case of a single predetermined document type (document type to be identified) (case where a single document type is to be identified) has been described. In a second embodiment, implementation in the case of a plurality of predetermined document types (case where a plurality of document types are to be identified) will be described. Note that in the present embodiment, implementation will be described in which a plurality of trained models each of which identifies a single document type are used to identify the plurality of document types.

Since the system configuration according to the present embodiment is substantially the same as that described in the first embodiment with reference to FIG. 1, description thereof is omitted. In addition, since the functional configuration of a training apparatus according to the present embodiment is substantially the same as that described in the first embodiment with reference to FIG. 2, description thereof is omitted. However, unlike the first embodiment, the training apparatus 2 according to the present embodiment performs the above-described training process (see FIG. 15) for each of the plurality of predetermined document types, and generates the high-frequency word list and the trained model for each of the plurality of predetermined document types. Note that the high-frequency word list may be generated for each document type, or may be a list that stores frequently occurring word strings of each document type.

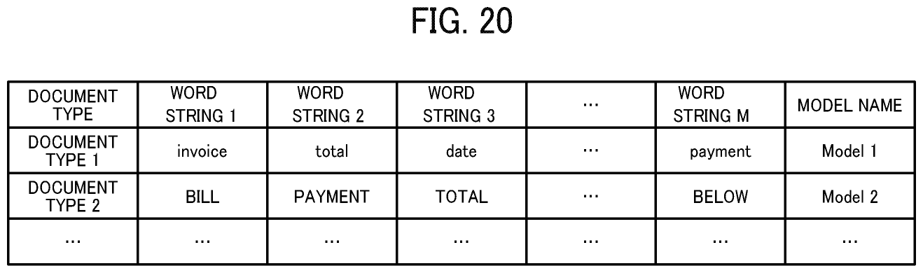

FIG. 20 is a diagram illustrating an example of the high-frequency word list according to the present embodiment. As illustrated in FIG. 20, the high-frequency word list stores in association with one another identification information of each predetermined document type, frequently occurring word strings (word strings 1 to M (M frequently occurring word strings)) of the predetermined document type, and identification information (such as a model name) of a trained model for identifying the predetermined document type. Note that the identification information of the document type may be any information indicating the document type, such as a document type name (such as a document type 1, or a document type 2), a number, or a symbol. As described above, the high-frequency word list is a list storing frequently occurring word strings of the plurality of predetermined document types. Note that the number of frequently occurring word strings may not be common (same) for all the document types.

In addition, since the functional configuration of an information processing apparatus according to the present embodiment is substantially the same as that described in the first embodiment with reference to FIG. 14, description thereof is omitted. However, unlike the first embodiment, in the present embodiment, the information processing apparatus 1 identifies, for each of the plurality of predetermined document types, whether an identification target image is an image of the predetermined document type. Thus, each of the functional units other than the image acquisition unit 41 performs the processing for each of the plurality of predetermined document types. Note that the identification unit 47 identifies the document type of the identification target document (target document of the identification target image), based on identified results about whether the identification target document corresponds to each of the plurality of predetermined document types. Specifically, the identification unit 47 adopts one result from among a plurality of identification results to identify the document type of the identification target document.

As a result of determining whether the identification target document corresponds to each of the plurality of predetermined document types, if a single document type is determined to correspond, the identification unit 47 identifies (determines) that the determined document type is the document type of the identification target document. On the other hand, if a plurality of document types are determined to correspond, the identification unit 47 may use any of the methods below to select a single document type from among the plurality of document types, and identifies (determines) the selected document type is the document type of the identification target document.

Selection based on Output (Likelihood) of Trained Model

A single document type may be selected based on the probabilities (such as likelihoods or reliabilities) of the identification target document being a document of each predetermined document type, output by the respective trained models. For example, the document type with the highest probability is determined (estimated) to be the document type of the identification target document.

Selection based on Past Identification Frequency

A single document type may be selected based on identification results (identification frequency) of the past identification target images. For example, a single document type may be selected based on the frequency with which (the number of times) the past identification target document is identified to be the document of the predetermined document type. Specifically, the document type with the highest number of times the past identification target document is identified (determined) to correspond to the predetermined document type is determined (estimated) to be the document type of the identification target document. Note that when this method is used to determine the document type, the information processing apparatus 1 includes a history information storage unit, which may be implemented by any desired memory, to store past identification results.

Selection based on Past Identification Timing

A single document type may be selected based on identification timings (identified timings) of the past identification target images. For example, a single document type may be selected based on the timings at which the past identification target document is identified to be the document of the predetermined document type. Specifically, the document type for which the past identification target document is identified (determined) to correspond to the predetermined document type more recently is determined (estimated) to be the document type of the identification target document. Note that when this method is used to determine the document type, the information processing apparatus 1 includes a history information storage unit, which may be implemented by any desired memory, to store past identification timings.

Selection based on User Selection

The plurality of document types determined to correspond may be displayed. In response to the user selecting one document type from among the plurality of displayed document types, a single document type may be selected. Note that when this method is used to determine the document type, the information processing apparatus 1 includes a display unit, which is implemented by any desired display, to display the document types determined to correspond, and an instruction receiving unit, which may be implemented by any desired user interface, to receive a selection instruction from the user.

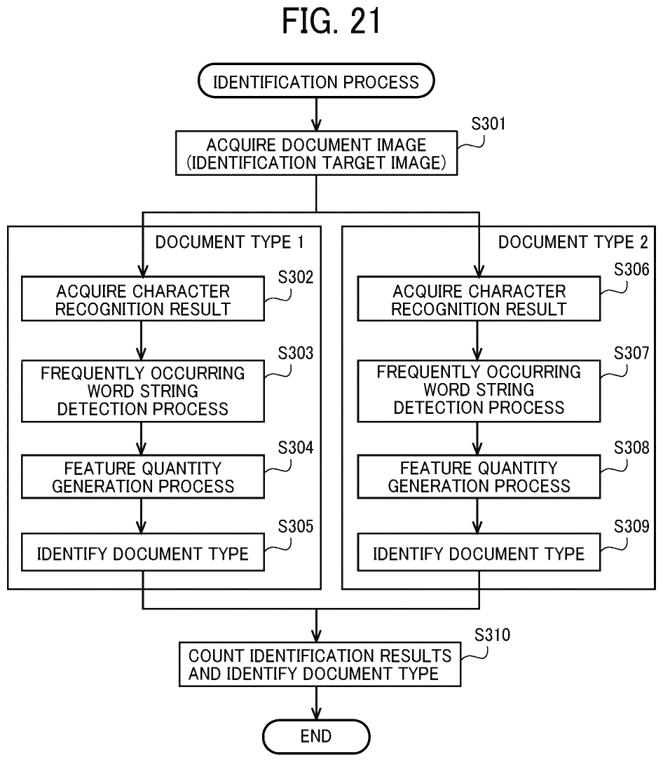

FIG. 21 is a flowchart illustrating an overview of a flow of an identification process according to the present embodiment. The process illustrated by this flowchart is performed by the information processing apparatus 1 in response to a trigger such as receipt of a scan instruction for a document. Note that this flowchart may be performed in response to a trigger such as receipt of a user instruction to acquire a form image stored in the storage device 14. Note that this flowchart illustrates the case where the document types to be identified (predetermined document types) are two types (document type 1 and document type 2). However, in the case where the document types to be identified are three or more types, the document type is to be identified if a process similar to that of this flowchart is performed.

In step S301, a document image (identification target image) is acquired. The image acquisition unit 41 acquires a scanned image of an identification target document. The process then proceeds to step S302 and step S306. Thereafter, processing of step S302 to S305 (processing of identifying whether the identification target document corresponds to the document type 1) and processing of steps S306 to S309 (processing of identifying whether the identification target document corresponds to the document type 2) are performed in parallel.

In step S302, a character recognition result (full-text OCR result) is acquired. Since the processing of step S302 is substantially the same as the processing of step S202 in FIG. 19, a detailed description is omitted. The process then proceeds to step S303.

In step S303, a frequently occurring word string detection process is performed. The detection unit 45 receives the high-frequency word list for the document type 1, which is stored in the frequently occurring word storage unit 43, and performs a detection process of the frequently occurring word strings of the document type 1 stored in the high-frequency word list. Note that since the processing of step S303 is substantially the same as the processing of step S203 in FIG. 19, a detailed description is omitted. The process then proceeds to step S304.

In step S304, a feature quantity generation process is performed. Based on the position information acquired in step S303, the feature generation unit 46 generates feature quantities (feature array) of the document depicted in the identification target image acquired in step S301. Since the processing of step S304 is substantially the same as the processing of step S204 in FIG. 19, a detailed description is omitted. The process then proceeds to step S305.

In step S305, it is identified whether the identification target document is the document of the predetermined document type (document type 1). The identification unit 47 receives the trained model for the document type 1, which is stored in the model storage unit 44. The identification unit 47 then inputs the feature quantities generated in step S304, to the received trained model to identify whether the identification target document is the document of the document type 1. Since the processing of step S305 is substantially the same as the processing of step S205 in FIG. 19, a detailed description is omitted. The process then proceeds to step S310.

Note that since the identification processing for the document type 2 (steps S306 to S309) is substantially the same as the above-described identification processing for the document type 1 (steps S302 to S305) except that the target document type alone is different, a description is omitted.

In step S310, the identification result is counted, the document type of the identification target document is identified, and the identified result is output. Based on the identification result as to whether the identification target document corresponds to the document type 1 and the identification result as to whether the identification target document corresponds to the document type 2, the identification unit 47 identifies the document type of the identification target document. For example, if the identification result in step S305 is “corresponding to the document type 1” and the identification result in step S309 is “not corresponding to the document type 2”, the identification target document is identified (determined) to correspond to the document type 1 (be the document of the document type 1), and the result is output. The process illustrated by the flowchart then ends.

Note that in the example described above, the identification processing for the document type 1 and the identification processing for the document type 2 are performed in parallel. However, the configuration is not limited to this example, and after the identification processing for the document type 1 is ended, the identification processing for the document type 2 may be performed. In addition, instead of performing processing of acquiring the character recognition result for each document type as illustrated in the example of FIG. 21, the character recognition result of an identification target image may be acquired once, and the acquired result may be used for all the document types.

### Third Embodiment

In the second embodiment, implementation has been described in which the plurality of trained models each of which identifies a single document type are used to identify the plurality of document types. In a third embodiment, implementation will be described in which a single trained model that identifies a plurality of document types is used to identify the plurality of document types.

Since the system configuration according to the present embodiment is substantially the same as that described in the first embodiment with reference to FIG. 1, description thereof is omitted. In addition, since the functional configuration of a training apparatus according to the present embodiment is substantially the same as that described in the first embodiment with reference to FIG. 2, description thereof is omitted. In addition, since the flow of a training process according to the present embodiment is substantially the same as that described in the first embodiment with reference to FIG. 15, description thereof is omitted. However, unlike the first embodiment, the training apparatus 2 according to the present embodiment generates, through a training process, a single trained model that identifies a plurality of predetermined document types. Thus, the ground truth definition acquired by the ground truth definition acquisition unit 53, the high-frequency word list generated by the frequently occurring word acquisition unit 54, the feature quantities (feature array) generated by the feature generation unit 56, and so on are different from those of the first embodiment.

Specifically, the ground truth definition acquisition unit 53 acquires a ground truth definition in which each training image (identification information of each training image) is associated with information (such as a label) indicating which document type among the plurality of predetermined document types a document depicted in the training image corresponds to. For example, in the case where the document types to be identified (predetermined document types) are the document type 1 (invoice) and the document type 2 (bill), a label “1” is associated with a training image if the training image is of the document type 1, a label “2” is associated with a training image if the training image is of the document type 2, and a label “0” is associated with a training image if the training image corresponds to neither the document type 1 nor the document type 2 in the ground truth definition. Note that whether to use an image of a document that corresponds to none of the document types in the training process is optional.

The frequently occurring word acquisition unit 54 acquires (extracts) frequently occurring word strings of each of the plurality of predetermined document types, and generates a high-frequency word list storing the acquired frequently occurring word strings of each of the plurality of predetermined document types. Specifically, the frequently occurring word acquisition unit 54 groups training images for each document type (predetermined document type), and extracts the frequently occurring word strings for each group (document type). For example, the processing of steps S1041 to S1044 is performed on a plurality of training images (invoice images) corresponding to the document type 1 (invoice), so that frequently occurring word strings of the document type 1 are extracted and a high-frequency word list of the document type 1 storing the frequently occurring word strings is generated. The similar processing is performed for the other document types, so that frequently occurring word strings are extracted (high-frequency word list is generated) for each document type. Note that the high-frequency word list is not generated for each document type and may be a single list including the frequently occurring word strings of the document types as described above. In the present embodiment, since the trained model is not generated for each document type, the identification information (model name) of the trained model may be omitted unlike the high-frequency word list illustrated in FIG. 20.

The detection unit 55 acquires, for each training image (document), position information related to the frequently occurring word strings of each of the plurality of predetermined document types. The detection unit 55 acquires a position of each frequently occurring word string stored in the high-frequency word list (all the high-frequency word lists when the list is generated for each document type) in the document. That is, the detection unit 55 acquires, for each training image (document), the position information related to each frequently occurring word string of each document type (when the document types to be identified (predetermined document types) are the document type 1 and the document type 2, each of the frequently occurring word strings of the document types 1 and 2).

Based on the position information acquired by the detection unit 55, the feature generation unit 56 generates feature quantities (feature array) of the document depicted in the training image. Note that in the present embodiment, feature quantities (position feature quantity, distance feature quantity, size feature quantity, and row feature quantity) related to each frequently occurring word string of each of the plurality of predetermined document types (all the document types to be identified) are stored in the feature array. For example, when the document types to be identified (predetermined document types) are the document type 1 and the document type 2, feature quantities related to each of the frequently occurring word strings of the document types 1 and 2 are stored. However, the distance feature quantity calculated between frequently occurring word strings of the same document type is stored.

The model generation unit 57 performs machine learning using training data to generate a trained model for identifying the plurality of predetermined document types. In the training data, the feature quantities (feature array), generated in the feature generation unit 56, of the document depicted in each training image are associated with information indicating which document type among the plurality of predetermined document types the document depicted in the training image corresponds to (i.e., information based on the ground truth definition). That is, an identifier (trained model) is generated which outputs, in response to receipt of feature quantities of a document including a positional relationship feature quantity related to a positional relationship in the document between a frequently occurring word string of each of the plurality of predetermined document types and another word string, information indicating the appropriateness of the document being a document of each of the plurality of predetermined document types.

Note that in the present embodiment, to enable identification of the plurality of predetermined document types, feature quantities related to frequently occurring word strings of each of the plurality of predetermined document types are generated (and stored in a single feature array). Thus, the generated feature quantities (the feature quantities stored in the feature array) is vast. Accordingly, to reduce the feature quantities (feature quantities (the position feature quantity, the distance feature quantity, the size feature quantity, and the row feature quantity of each frequently occurring word string) stored in the feature array, following methods are usable.

Removal of Overlapping Frequently Occurring Word Strings across Document Types

If there are overlapping frequently occurring word strings across a plurality of (two or more) document types, the overlapping frequently occurring word strings may be removed from the frequently occurring word strings to be used in generation of the feature quantities.

### Use of Pair of Frequently Occurring Word Strings Having Average Distance of Threshold Value or Smaller

Among combinations (pairs) of two frequently occurring word strings of the predetermined document type (for example, invoice), a distance between the frequently occurring word strings of a combination satisfying a predetermined condition may be used in calculation of the feature quantities. The combination satisfying the predetermined condition is a combination of frequently occurring word strings for which a representative value (average value) of the distance between the frequently occurring word strings in the plurality of training images that are images of the predetermined document type (invoice) is less than or equal to a certain value. For example, after frequently occurring word strings are extracted from a plurality of training images (for example, 100 images) which are images of the document type 1 (invoice), the distance between word strings are calculated for all of the combinations (pairs) of frequently occurring word strings in each of the training images (in each of the 100 images). Pairs of frequently occurring word strings for which the average value of the distance between the frequently occurring word strings in the 100 training images is less than or equal to a predetermined threshold value may be determined as word string pairs to be used in calculation of the distance feature quantities.

### Use of Feature Quantities Having High Use Frequency

The trained model can acquire the feature quantities that has been used in identification as a result of performing the document type identification process using the generated trained model. Thus, the feature array may be changed so that the feature quantities frequently used in actual identification process (feature quantities having a high use frequency) are used.

### Removal of Feature Quantities Having High Correlation

If the feature quantities include feature quantities having a high correlation, one feature quantity among the feature quantities having the high correlation is used as the feature quantities of the document depicted in the training image, and the other feature quantity may be excluded from the feature quantities of the document depicted in the training image.

### Reduction of Dimension by Principal Component Analysis

The principal component analysis (PCA) may be used to reduce the dimension of the feature quantities.

Since the functional configuration of an information processing apparatus according to the present embodiment is substantially the same as that described in the first embodiment with reference to FIG. 14, description thereof is omitted. In addition, since the flow of an identification process according to the present embodiment is substantially the same as that described in the first embodiment with reference to FIG. 19, description thereof is omitted.

However, in the present embodiment, the frequently occurring word storage unit 43 stores the above-described frequently occurring word strings of each of the plurality of predetermined document types (a high-frequency word list, generated by the frequently occurring word acquisition unit 54, storing the frequently occurring word strings of each of the plurality of predetermined document types). The model storage unit 44 stores the above-described trained model that is generated by the model generation unit 57 and identifies the plurality of predetermined document types. The detection unit 45 acquires information on the positions of the frequently occurring word strings of each of the plurality of predetermined document types in the identification target document. The feature generation unit 46 uses the information acquired by the detection unit 45 to generate feature quantities of the identification target document (feature quantities related to the frequently occurring word strings of each of the plurality of predetermined document types). Note that the details of the feature quantities related to the frequently occurring word strings are substantially the same as those of the first embodiment.

The identification unit 47 inputs the feature quantities of the identification target document to the trained model that identifies the plurality of predetermined document types, and thus acquires information indicating appropriateness of the identification target document being a document of each of the plurality of predetermined document types (for example, if the document types to be identified (predetermined document types) are the document type 1 and the document type 2, information indicating appropriateness of the identification target document being of the document type 1 and information indicating appropriateness of the identification target document being of the document type 2). Based on the acquired information indicating the appropriateness, the identification unit 47 identifies whether the identification target document is the document of which document type among the plurality of predetermined document types. For example, based on likelihoods (such as reliabilities) of being documents of the respective document types output from the trained model, the identification unit 47 can determine (identify) a document type having the highest likelihood as the document type of the identification target document.

In the related art, various techniques such as a method using ruled line information and a method of identifying a particular document type based on the presence or absence of a particular word written merely in the particular document type and the position of the particular word have been proposed as techniques for identifying the type of a document.

However, in the case of documents of the same kind having various layouts (formats), such as semi-fixed-format forms, words written in the documents and positions of the ruled line and words vary from document to document. Therefore, it is difficult to identify the document type of such a document having an unfixed layout.

According to the embodiments of the present disclosure, the document type can be appropriately identified even for a document having an unfixed layout.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.
The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality.
Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

The present disclosure can be understood as an information processing apparatus, a system, and a computer; a method executed by an information processing apparatus, a system, or a computer; or a program executed by a computer. Further, the present disclosure can also be understood as a recording medium that stores such a program and that can be read by, for example, a computer or any other apparatus or machine. The recording medium that can be read by, for example, the computer refers to a recording medium that can store information such as data or programs by electrical, magnetic, optical, mechanical, or chemical action, and that can be read by, for example, a computer.

According to one embodiment, a program executes following functions. The following functions include
recognition result acquisition means to acquire a character recognition result of an identification target image that is an image of an identification target document;
frequently occurring word storage means to store a frequently occurring word string of a predetermined document type;
detection means to detect the frequently occurring word string from the character recognition result of the identification target image to acquire information on a position of the frequently occurring word string in the identification target document;
feature generation means to use the information on the position to generate a feature quantity of the identification target document, the feature quantity including a positional relationship feature quantity related to a positional relationship between the frequently occurring word string and another word string in the identification target document;
model storage means to store a trained model that identifies the predetermined document type, the trained model being generated through machine learning to output, in response to receipt of a feature quantity of a document including a positional relationship feature quantity related to a positional relationship between the frequently occurring word string and another word string in the document, information indicating appropriateness of the document being a document of the predetermined document type; and
identification means to input the feature quantity of the identification target document to the trained model to identify whether the identification target document is a document of the predetermined document type.

According to one embodiment, a program executes following functions. The following functions include
recognition result acquisition means to acquire a character recognition result of each of a plurality of training images including a plurality of predetermined document type images that are images of documents of a predetermined document type having layouts different from one another;
frequently occurring word acquisition means to acquire a frequently occurring word string of the predetermined document type;
detection means to detect the frequently occurring word string from the character recognition result of each of the plurality of training images to acquire information on a position of the frequently occurring word string in a document depicted in the training image;
feature generation means to use the information on the position of the frequently occurring word string in the document depicted in each of the plurality of training images to generate a feature quantity of the document depicted in the training image, the feature quantity including a positional relationship feature quantity related to a positional relationship between the frequently occurring word string and another word string in the document depicted in the training image; and
model generation means to generate a trained model that identifies the predetermined document type, the trained model being generated through machine learning using training data in which the feature quantity of the document depicted in each of the plurality of training images is associated with information indicating whether the document depicted in the training image is a document of the predetermined document type.

1. An information processing system comprising:
circuitry configured to:
acquire a character recognition result of an identification target image that is an image of an identification target document;
store a frequently occurring word string of a predetermined document type;
detect the frequently occurring word string from the character recognition result of the identification target image to acquire information on a position of the frequently occurring word string in the identification target document;
generate a feature quantity of the identification target document using the information on the position, the feature quantity including a positional relationship feature quantity related to a positional relationship between the frequently occurring word string and another word string in the identification target document;
store a trained model that identifies the predetermined document type, the trained model being generated through machine learning such that, in response to input of a feature quantity of a document including a positional relationship feature quantity related to a positional relationship between the frequently occurring word string and another word string in the document, information indicating appropriateness of the document being a document of the predetermined document type is output; and
input the feature quantity of the identification target document to the trained model to identify whether the identification target document is a document of the predetermined document type.

2. The information processing system of claim 1, wherein the trained model is generated through machine learning using training data,
the training data associating, for each of a plurality of training images including a plurality of predetermined document type images that are images of documents of the predetermined document type having layouts different from one another, a feature quantity of a document depicted in the training image with information indicating whether the document depicted in the training image is a document of the predetermined document type,
the feature quantity of a document depicted in the training image including a positional relationship feature quantity related to a positional relationship between the frequently occurring word string and another word string in the document depicted in the training image.

3. The information processing system of claim 1, wherein the frequently occurring word string is one of a plurality of frequently occurring word strings, and
the positional relationship feature quantity includes a feature quantity indicating a distance between the frequently occurring word string and another frequently occurring word string in the identification target document.

4. The information processing system of claim 1, wherein the positional relationship feature quantity includes a feature quantity indicating a size of a row including the frequently occurring word string.

5. The information processing system of claim 1, wherein the feature quantity of the identification target document includes the positional relationship feature quantity and a feature quantity indicating an attribute of the frequently occurring word string.

6. The information processing system of claim 5, wherein the feature quantity indicating the attribute of the frequently occurring word string includes at least one of a feature quantity indicating a position of the frequently occurring word string or a feature quantity indicating a size of the frequently occurring word string.

7. The information processing system of claim 2, wherein the circuitry is configured to:
store the trained model generated using training data,
the training data associating a feature array with information indicating whether the document depicted in each of the plurality of training images is a document of the predetermined document type, the feature array having the feature quantity of the document depicted in each of the plurality of training images been aggregated in an array form;
form the feature quantity of the identification target document in an array in same arrangement order as the feature array; and
input, to the trained model, the feature quantity of the identification target document formed in the array, to identify whether the identification target document is a document of the predetermined document type.

8. The information processing system of claim 1, wherein
the predetermined document type is one of a plurality of predetermined document types, and
the circuitry is configured to:
store, for each of the plurality of predetermined document types, a trained model that identifies the predetermined document type;
for each of the plurality of predetermined document types, identify whether the identification target image corresponds to the predetermined document type using the trained model that identifies the predetermined document type; and
identify, based on a result of the identification for each of the plurality of predetermined document types, which document type among the plurality of predetermined document types the identification target document corresponds to.

9. The information processing system of claim 8, wherein the circuitry is configured to:
in a case where the identification target document is identified to be a document of two or more predetermined document types as a result of identification performed for each of the plurality of predetermined document types,
select a document type from the two or more predetermined document types; and
determine the selected document type as the document type of the identification target document.

10. The information processing system of claim 9, wherein the circuitry is configured to select a document type from the two or more predetermined document types, based on a probability of the identification target document being a document of each of the two or more predetermined document type.

11. The information processing system of claim 9, wherein the circuitry is configured to select a document type from the two or more predetermined document types, based on a number of times each of the two or more predetermined document types was identified as the document type of the identification target document by the trained model in past.

12. The information processing system of claim 9, wherein the circuitry is configured to select a document type from the two or more predetermined document types, based on a timing at which each of the two or more predetermined document types was identified as the document type of the identification target document by the trained model.

13. The information processing system of claim 1, wherein
the predetermined document type is one of a plurality of predetermined document types, and
the circuitry is configured to:
store a frequently occurring word string of each of the plurality of predetermined document types;
acquire information on a position of the frequently occurring word string of each of the plurality of predetermined document types in the identification target document;
generate a feature quantity of the identification target document using the information on the position, the feature quantity including a positional relationship feature quantity related to a positional relationship between the frequently occurring word string of each of the plurality of predetermined document types and another word string in the identification target document;
store a trained model that identifies the plurality of predetermined document types,
the trained model being generated through machine learning such that, in response to input of a feature quantity of a document including a positional relationship feature quantity related to a positional relationship between the frequently occurring word string of each of the plurality of predetermined document types and another word string in the document, information indicating appropriateness of the document being a document of each of the plurality of predetermined document types is output; and
input the feature quantity of the identification target document to the trained model that identifies the plurality of predetermined document types, to identify which document type among the plurality of predetermined document types the identification target document corresponds to.

14. The information processing system of claim 13, wherein in a case where the plurality of predetermined document types have an overlapping frequently occurring word string, the positional relationship feature quantity is a positional relationship feature quantity related to a positional relationship between the frequently occurring word string of each of the plurality of document types and another word string, the frequently occurring word string of each of the predetermined document types being not the overlapping frequently occurring word string.

15. The information processing system of claim 13, wherein
the positional relationship feature quantity includes a feature quantity indicating a distance between frequently occurring word strings of a combination satisfying a predetermined condition among combinations of two frequently occurring word strings of the predetermined document type, and
the combination satisfying the predetermined condition is a combination of frequently occurring word strings for which a representative value of a distance between the frequently occurring word strings in the plurality of training images that are images of the predetermined document type is less than or equal to a certain value.

16. An information processing system comprising:
circuitry configured to:
acquire a character recognition result of each of a plurality of training images including a plurality of predetermined document type images that are images of documents of a predetermined document type having layouts different from one another;
acquire a frequently occurring word string of the predetermined document type;
detect the frequently occurring word string from the character recognition result of each of the plurality of training images to acquire information on a position of the frequently occurring word string in a document depicted in the training image;
generate a feature quantity of the document depicted in the training image using the information on the position of the frequently occurring word string in the document depicted in each of the plurality of training images, the feature quantity including a positional relationship feature quantity related to a positional relationship between the frequently occurring word string and another word string in the document depicted in the training image; and
generate a trained model that identifies the predetermined document type, the trained model being generated through machine learning using training data,
the training data associating the feature quantity of the document depicted in each of the plurality of training images with information indicating whether the document depicted in the training image is a document of the predetermined document type.

17. The information processing system of claim 16, wherein the circuitry is configured to:
extract a word string that appears in documents depicted in the plurality of predetermined document type images, based on the character recognition results of the plurality of predetermined document type images; and
acquire the extracted word string as the frequently occurring word string of the predetermined document type.

18. The information processing system of claim 16, wherein the circuitry is configured to:
acquire a ground truth definition in which identification information of each of the plurality of training images is associated with information indicating whether a document depicted in the training image is a document of the predetermined document type; and
acquire, based on the ground truth definition, the information indicating whether a document depicted in a training image among the plurality of training images is a document of the predetermined document type.

19. A document type identification method comprising:
acquiring a character recognition result of an identification target image that is an image of an identification target document;
storing a frequently occurring word string of a predetermined document type;
detecting the frequently occurring word string from the character recognition result of the identification target image to acquire information on a position of the frequently occurring word string in the identification target document;
generating a feature quantity of the identification target document using the information on the position, the feature quantity including a positional relationship feature quantity related to a positional relationship between the frequently occurring word string and another word string in the identification target document;
storing a trained model that identifies the predetermined document type, the trained model being generated through machine learning such that, in response to input of a feature quantity of a document including a positional relationship feature quantity related to a positional relationship between the frequently occurring word string and another word string in the document, information indicating appropriateness of the document being a document of the predetermined document type is output; and
inputting the feature quantity of the identification target document to the trained model to identify whether the identification target document is a document of the predetermined document type.

20. A model generation method comprising:
acquiring a character recognition result of each of a plurality of training images including a plurality of predetermined document type images that are images of documents of a predetermined document type having layouts different from one another;
acquiring a frequently occurring word string of the predetermined document type;
detecting the frequently occurring word string from the character recognition result of each of the plurality of training images to acquire information on a position of the frequently occurring word string in a document depicted in the training image;
generating a feature quantity of the document depicted in the training image, using the information on the position of the frequently occurring word string in the document depicted in each of the plurality of training images, the feature quantity including a positional relationship feature quantity related to a positional relationship between the frequently occurring word string and another word string in the document depicted in the training image; and
generating a trained model that identifies the predetermined document type, the trained model being generated through machine learning using training data,
the training data associating the feature quantity of the document depicted in each of the plurality of training images with information indicating whether the document depicted in the training image is a document of the predetermined document type.
